(19) United States
(12) Patent Application Publication
(10) Pub. No.: US 2026/0370683 A1
(43) Pub. Date: Nov. 19, 2026

(54) DEFENSE MECHANISMS AGAINST UNDETECTABLE CYBERATTACKS ON NETWORKED ROBOT CONTROL SYSTEMS

(71) Applicant: Georgia Tech Research Corporation, Atlanta, GA (US)

(72) Inventors: Jun Ueda, Atlanta, GA (US); Hyuk Bin Kwon, Atlanta, GA (US); Jacob Blevins, Atlanta, GA (US)

(21) Appl. No.: 19/677,441

(22) Filed: May 14, 2026

Related U.S. Application Data
(60) Provisional application No. 63/805,739, filed on May 14, 2025.

(51) Int. Cl. H04L 9/40; H04L 9/00

(52) U.S. Cl. CPC H04L 63/1466; H04L 9/008

(57) ABSTRACT

The present disclosure relates generally to cybersecurity in networked robot control systems, and more particularly to detecting false data injection attacks. A method includes receiving state measurements at a motion control unit, processing the state measurements through a non-equivariant state monitoring signature function to compute a first signature value where no transformation can simultaneously transform both the state measurements and the first signature value while maintaining mathematical consistency, and transmitting the first signature value and state measurements to a remote controller. The method includes processing the received state measurements to compute a second signature value, comparing the signature values, encrypting control commands using homomorphic encryption, transmitting the encrypted control commands to the motion control unit, monitoring the encrypted control commands for anomalous noise levels, and generating an alert responsive to the signature value difference exceeding a threshold or the commands exhibiting anomalous noise levels.

### CROSS-REFERENCE TO RELATED APPLICATIONS

This application claims the benefit of U.S. Provisional Application Ser. No. 63/805,739, filed on 14 May 2025, which is incorporated herein by reference in its entirety as if fully set forth below.

### GOVERNMENT LICENSE RIGHTS

This invention was made with government support under 2112793 awarded by the National Science Foundation. The government has certain rights in this invention.

### FIELD OF INVENTION

The present disclosure relates to cybersecurity in networked robot control systems, and more particularly to methods and systems for detecting false data injection attacks through the implementation of non-equivariant state monitoring signature functions and encryption-based overflow traps.

### BACKGROUND

Robotic systems have become integral to a broad spectrum of applications, particularly in scenarios where human intervention is either impractical or inefficient. These applications range from industrial automation and logistics, where mobile robots handle materials, to exploration and data collection in hazardous environments such as deep-sea locations, disaster sites, and space missions. Virtually all current robotic systems are interconnected through computer networks for exchanging sensor measurements, control commands, and other information for monitoring and controlling purposes. The operation of these mobile robots often relies on networked communication systems to receive commands and transmit data back to operators or control servers. In some implementations, control calculations may be taken out of the plant and placed in the cloud, which can reduce computational effort at the plant, saving both time and resources while allowing for resource pooling and rapid scalability.

Current approaches to securing cyber-physical systems typically involve encryption of communication channels, intrusion detection systems, and robust control methods. Common compensation strategies from the control-theoretical standpoint include robust optimal control, adaptive control, and state and disturbance compensation. For anomaly detection associated with false data injection, a model-based control approach may be employed where the controller compares observed plant behaviors induced by its control commands with those simulated based on a nominal plant dynamic model. Any discrepancies identified through this process could indicate potential false-data injection, disturbances, or plant uncertainties. Encrypting communication lines or control algorithms adds another layer of protection, and advanced encryption techniques such as homomorphic encryption schemes have been proposed for securing networked controllers while allowing mathematical operations to be performed on encrypted data.

However, existing approaches suffer from several limitations. The networked nature of robotic systems, while enabling remote and autonomous operations, is also susceptible to cybersecurity threats. One threat is false data injection attacks, where an attacker manipulates the data being sent to or from the robot, or both, leading to incorrect actions, decision-making based on false information, or even taking control of the robot's operations. In a scenario where an attacker already has access to the network, such as an insider attack or a data breach, conventional encryption alone does not guarantee security. Advanced encryption techniques such as homomorphic encryption schemes possess known malleability vulnerabilities that can be exploited to apply false data injection attacks. In more sophisticated scenarios, attackers could inject false data to make the robot's system believe it is operating normally while it performs unintended tasks. These attacks, referred to as undetectable or stealthy attacks, present particular challenges because attacked signals coincide with those that are within regular operating range, and thus conventional fault detection methods may fail to identify the intrusion. If the controller observes small changes under the detection threshold or none at all in the plant dynamics between normal and attacked states, model-based anomaly detection may be ineffective.

What is needed, therefore, are improved methods and systems for detecting sophisticated false data injection attacks in networked robot control systems, including attacks that maintain mathematical consistency from the controller's perspective and thus evade conventional detection approaches.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

A computer-implemented method for detecting false data injection attacks in a networked robot control system can include receiving, at a motion control unit, state measurements from a robot system. The method can include processing the state measurements through a non-equivariant state monitoring signature function to compute a first signature value, wherein the non-equivariant state monitoring signature function is configured such that no transformation exists that can simultaneously transform both the state measurements and the first signature value while maintaining mathematical consistency. The method can include transmitting the first signature value and the state measurements to a remote controller via a communication network. The method can include, at the remote controller, processing the received state measurements through the non-equivariant state monitoring signature function to compute a second signature value. The method can include comparing the first signature value with the second signature value. The method can include encrypting control commands at the remote controller using homomorphic encryption. The method can include transmitting the encrypted control commands to the motion control unit via the communication network. The method can include monitoring the encrypted control commands for anomalous noise levels indicative of unauthorized manipulation. The method can include generating an alert responsive to at least one of: a difference between the first signature value and the second signature value exceeding a predefined threshold, or the encrypted control commands exhibiting anomalous noise levels.

A system for detecting false data injection attacks in a networked robot control system can include a robot plant including actuators and sensors. The system can include a motion control unit coupled to the robot plant, the motion control unit including a first processor, a first memory coupled to the first processor, and first instructions stored in the first memory that, when executed by the first processor, cause the motion control unit to receive state measurements from the sensors, process the state measurements through a non-equivariant state monitoring signature function to compute a first signature value, and transmit the first signature value and the state measurements via a communication network. The system can include a remote controller coupled to the motion control unit via the communication network, the remote controller including a second processor, a second memory coupled to the second processor, and second instructions stored in the second memory that, when executed by the second processor, cause the remote controller to receive the first signature value and the state measurements from the motion control unit, process the received state measurements through the non-equivariant state monitoring signature function to compute a second signature value, compare the first signature value with the second signature value to detect transformation-based attacks, encrypt control commands using homomorphic encryption, and transmit the encrypted control commands to the motion control unit. The system can include an encryption overflow detection module configured to monitor the encrypted control commands for anomalous noise levels and generate an alert responsive to detecting noise levels exceeding a predetermined threshold.

A computer-implemented method for detecting false data injection attacks in an encrypted networked robot control system can include determining encryption parameters for homomorphic encryption based on a maximum expected plaintext value and a maximum degree of operations to be performed in the control system. The method can include encrypting control commands using the homomorphic encryption with the determined encryption parameters. The method can include transmitting the encrypted control commands via a communication network to a robot system. The method can include receiving the encrypted control commands at the robot system. The method can include monitoring a noise characteristic of the encrypted control commands. The method can include calculating a detection probability based on the noise characteristic. The method can include generating an alert responsive to the detection probability exceeding a predefined threshold, wherein the alert indicates a potential false data injection attack.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a defense system for an encrypted telerobotic system, according to examples of the disclosed technology.

FIG. 2A illustrates a sequence diagram of detectable and undetectable false data injection attack scenarios, according to examples of the disclosed technology.

FIG. 2B illustrates a block diagram of an affine transformation-based attack applied to a mobile robot control system, according to examples of the disclosed technology.

FIG. 2C illustrates a block diagram of a covert attack mechanism on a mobile robot control system, according to examples of the disclosed technology.

FIG. 3A illustrates a computational graph representation of a control command calculation, according to examples of the disclosed technology.

FIG. 3B illustrates a computational graph representation of encrypted control operations, according to examples of the disclosed technology.

FIG. 4 is a block diagram of an example system that may be used to provide a combined defense architecture for an encrypted telerobotic control system, according to examples of the disclosed technology.

FIG. 5A illustrates plaintext overflow detection in an encrypted control system under attack conditions, according to examples of the disclosed technology.

FIG. 5B illustrates ciphertext overflow detection zones and frequency distributions for attacked and unattacked ciphertext values, according to examples of the disclosed technology.

FIG. 6 illustrates a relationship between attacked ciphertext values and frequency distribution in ciphertext overflow detection zones, according to examples of the disclosed technology.

FIG. 7A illustrates a graph of detection probability as a function of an encryption parameter for a modified model reference adaptive control implementation, according to examples of the disclosed technology.

FIG. 7B illustrates a graph of detection probability as a function of an encryption parameter for an unmodified model reference adaptive control implementation, according to examples of the disclosed technology.

FIG. 8 illustrates execution time as a function of time for different encryption parameter configurations, according to examples of the disclosed technology.

FIG. 9A illustrates output measurements for a mobile robot trajectory tracking control system under a first condition, according to examples of the disclosed technology.

FIG. 9B illustrates output measurements for a mobile robot trajectory tracking control system under a second condition, according to examples of the disclosed technology.

FIG. 9C illustrates output measurements for a mobile robot trajectory tracking control system under a third condition, according to examples of the disclosed technology.

FIG. 9D illustrates output measurements for a mobile robot trajectory tracking control system under attack conditions, according to examples of the disclosed technology.

FIG. 10 illustrates mobile robot trajectory tracking with reference and current postures, according to examples of the disclosed technology.

FIG. 11 illustrates mobile robot trajectories under different attack conditions, according to examples of the disclosed technology.

FIG. 12 is a block diagram of an example system that may be used to provide a combined defense architecture for detecting false data injection attacks, according to examples of the disclosed technology.

FIG. 13 illustrates a receiver operating characteristic curve comparing detection performance of two attack detection methods, according to examples of the disclosed technology.

FIG. 14 illustrates a percentage of attacks detected as a function of a parameter for two attack types, according to examples of the disclosed technology.

FIG. 15A illustrates tracking performance in a scenario with no attack, according to examples of the disclosed technology.

FIG. 15B illustrates state tracking performance under an additive attack scenario, according to examples of the disclosed technology.

FIG. 15C illustrates tracking performance for a first-order multiplicative scenario, according to examples of the disclosed technology.

FIG. 15D illustrates state tracking performance for a second-order multiplicative attack scenario, according to examples of the disclosed technology.

FIG. 16A illustrates decoded control signal values over time for a scenario with no attack, according to examples of the disclosed technology.

FIG. 16B illustrates decoded control signal values over time for an additive attack scenario, according to examples of the disclosed technology.

FIG. 16C illustrates decoded control signal values over time for a first-order multiplicative attack scenario, according to examples of the disclosed technology.

FIG. 16D illustrates decoded control signal values over time for a second-order multiplicative attack scenario, according to examples of the disclosed technology.

FIG. 17A illustrates decoded values over time for a scenario with no attack, according to examples of the disclosed technology.

FIG. 17B illustrates decoded values under an additive attack scenario, according to examples of the disclosed technology.

FIG. 17C illustrates decoded value behavior over time for a first-order multiplicative attack scenario, according to examples of the disclosed technology.

FIG. 17D illustrates decoded values over time for a second-order multiplicative attack scenario, according to examples of the disclosed technology.

FIG. 18 illustrates a response of a plant under a degree-2 attack scenario with trap firings indicated, according to examples of the disclosed technology.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to methods and systems for detecting false data injection attacks in networked robot control systems. Networked robot control systems can be vulnerable to sophisticated cyberattacks where an attacker manipulates data transmitted between a robot plant and a remote controller. In some cases, attackers can implement attacks that maintain mathematical consistency from the controller's perspective, making such attacks difficult or impossible to detect using conventional anomaly detection methods. These attacks, referred to as undetectable or stealthy attacks, can cause a robot to deviate from intended behavior while the controller observes nominal dynamics.

Two categories of undetectable attacks present particular challenges for networked robot control systems. A first category includes affine transformation-based attacks, where an attacker applies coordinated transformations to both control commands and state measurements. By manipulating variables through operations such as scaling, reflection, or permutation, attackers can alter a robot's behavior while preserving mathematical structures that would otherwise reveal the attack. A second category includes covert attacks, where a malicious controller is implemented between a plant and a networked controller. The malicious controller provides an alternate control objective while simultaneously inverting plant observables such that the legitimate controller does not observe anomalies.

The disclosed technology provides two complementary defense mechanisms that operate in parallel to detect different types of undetectable attacks. A first defense mechanism employs non-equivariant state monitoring signature functions (SMSFs). A non-equivariant state monitoring signature function computes a signature value from robot state measurements, where the function is mathematically designed such that no transformation exists that can simultaneously transform both the state measurements and the signature value while maintaining mathematical consistency. When an attacker attempts to apply a transformation to manipulate state measurements, the attacker cannot apply a corresponding transformation to the signature value that would preserve the expected relationship. By computing signature values at both the robot plant and the remote controller and comparing the values, the system can detect transformation-based attacks that would otherwise remain undetectable.

A second defense mechanism employs an encryption overflow detection module that leverages noise characteristics of homomorphic encryption schemes. Homomorphic encryption allows mathematical operations to be performed on encrypted data without decryption. However, these operations cause noise to accumulate within ciphertext, with complex operations such as multiplication causing more noise growth than simple operations such as addition. The encryption overflow detection module works by tuning encryption parameters based on expected operations and detecting when noise levels exceed predetermined thresholds. Covert attacks can require computationally intensive operations involving polynomial expressions of encrypted values, which can cause noise accumulation that exceeds detection thresholds. The encryption overflow detection module can detect such attacks by monitoring for anomalous noise levels in encrypted control commands.

The two defense mechanisms are designed to complement each other by targeting different attack vectors. The non-equivariant state monitoring signature function can detect affine transformation-based attacks by ensuring that any attempt to apply the same transformation to both state measurements and signature values creates detectable inconsistencies. The encryption overflow trap can detect more complex attacks with higher computational requirements, such as covert attacks, by leveraging noise growth characteristics of homomorphic encryption. By implementing both mechanisms in parallel, the system can provide protection against a range of attack vectors. The non-equivariant state monitoring signature function can detect affine transformation-based attacks, while the encryption overflow trap can detect covert attacks. Both mechanisms can be applied simultaneously without interfering with each other, and the combined approach can provide detection capability with reduced false positive rates.

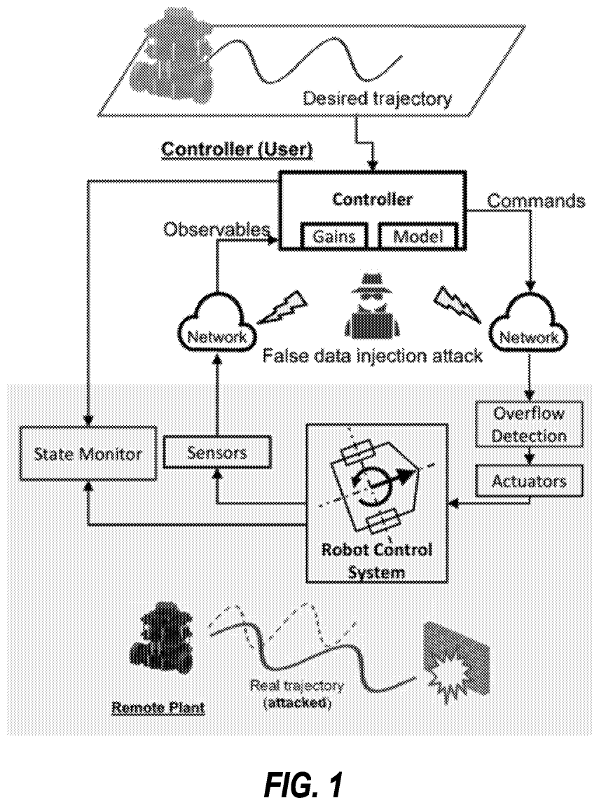

FIG. 1 illustrates a networked robot control system with a defense implementation according to examples of the disclosed technology. The system includes a robot plant, a motion control unit, a communication network, and a remote controller. The motion control unit implements a state monitoring signature function (SMSF) module that computes signature values based on robot state measurements. The remote controller implements a signature verification module and an encryption overflow detection module.

The robot plant can be an industrial manipulator, a mobile robot, or another robotic system. The robot plant includes actuators and sensors that interface with the physical environment. The sensors collect state measurements representing the current configuration and motion of the robot plant. The actuators receive control commands and execute physical movements based on the received commands.

The motion control unit is coupled to the robot plant. The motion control unit can include a first processor and a first memory coupled to the first processor. First instructions stored in the first memory, when executed by the first processor, cause the motion control unit to receive state measurements from the sensors. The motion control unit processes sensor data and generates control commands for the actuators. The motion control unit also implements the SMSF module, which processes the state measurements to compute a first signature value. The SMSF module can be referred to herein as a non-equivariant state monitoring signature function. The motion control unit transmits the first signature value and the state measurements via a communication network to the remote controller.

The motion control unit is coupled to the robot plant. The motion control unit can include a first processor and a first memory coupled to the first processor. First instructions stored in the first memory, when executed by the first processor, cause the motion control unit to receive state measurements from the sensors. The motion control unit processes sensor data and generates control commands for the actuators. The motion control unit also implements the SMSF module, which processes the state measurements to compute a first signature value. The SMSF module (state monitoring signature function module) can be referred to herein as a non-equivariant state monitoring signature function. The motion control unit transmits the first signature value and the state measurements via a communication network to the remote controller.

The remote controller is coupled to the motion control unit via the communication network. The remote controller can include a second processor and a second memory coupled to the second processor. Second instructions stored in the second memory, when executed by the second processor, cause the remote controller to receive the first signature value and the state measurements from the motion control unit. The remote controller processes the received state measurements through the same signature function implemented by the SMSF module to compute an expected signature value. The signature verification module compares the received signature value with the expected signature value computed locally.

The remote controller encrypts control commands using homomorphic encryption. Homomorphic encryption allows mathematical operations to be performed on encrypted data without decryption. The remote controller transmits the encrypted control commands to the motion control unit via the communication network. The motion control unit receives the encrypted control commands and decrypts the commands for application to the actuators of the robot plant.

The encryption overflow detection module monitors the encrypted control commands for anomalous noise levels. The encryption overflow detection module can be configured to generate an alert responsive to detecting noise levels exceeding a predetermined threshold. The encryption overflow detection module operates in conjunction with the signature verification module to detect different types of attacks. The signature verification module can detect transformation-based attacks by identifying discrepancies between received and expected signature values. The encryption overflow detection module can detect attacks that cause excessive noise accumulation in encrypted commands.

The system architecture supports a computer-implemented method for detecting false data injection attacks in a networked robot control system. State measurements flow from the robot plant through the sensors to the motion control unit. The motion control unit processes the state measurements through the SMSF module and transmits both the signature value and the state measurements to the remote controller. The remote controller computes control commands, encrypts the control commands using homomorphic encryption, and transmits the encrypted control commands back to the motion control unit. The two defense mechanisms operate in parallel to monitor for different attack vectors, with the SMSF-based detection targeting transformation-based attacks and the encryption overflow detection targeting attacks that involve polynomial operations on encrypted data.

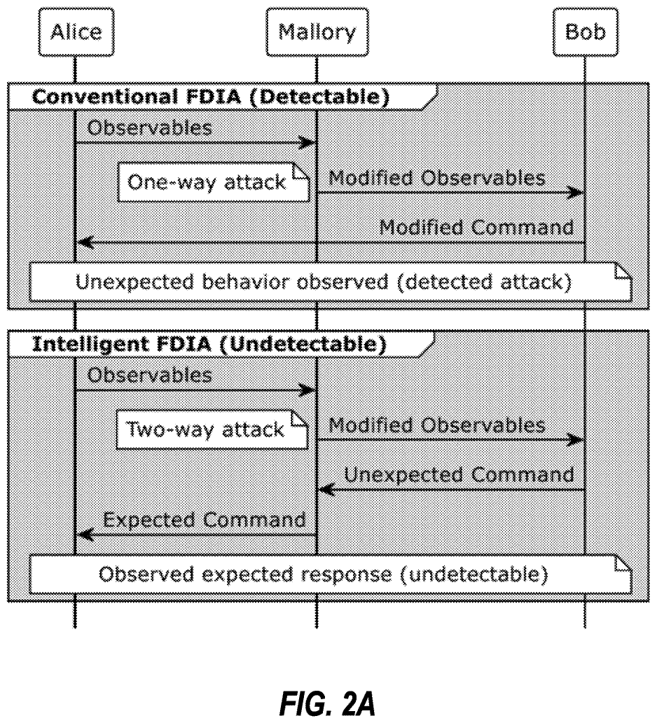

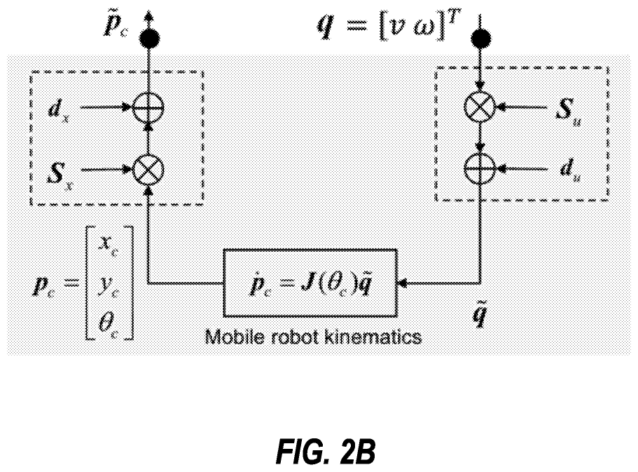

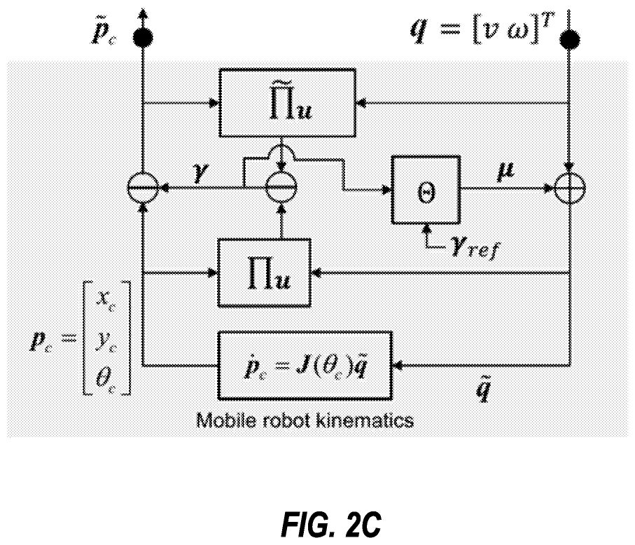

FIG. 2A illustrates a sequence diagram representing detectable and undetectable false data injection attack scenarios in a networked robot control system. The diagram depicts interactions between three entities: a first entity that functions as a remote plant, a second entity that represents an attacker, and a third entity that serves as a controller. The first entity can be referred to herein as Alice, the second entity can be referred to herein as Mallory, and the third entity can be referred to herein as Bob.

In the threat model, Alice transmits observables to Bob based on the location of Alice. Alice encrypts the location with a secret key and sends the encrypted location to Bob and waits for a response. Bob holds a public key that allows Bob to compute actuation commands for Alice. Mallory is a malicious actor that can intercept and modify traffic between Alice and Bob without noticeable network delays. Mallory can achieve interception through various means such as address resolution protocol (ARP) poisoning or domain name system (DNS) spoofing. Because homomorphic encryption does not provide authentication, without additional measures such as hash functions, there is no way for Alice to determine if a received message is actually from Bob and vice versa.

False data injection attacks can be classified into two categories: detectable attacks and undetectable attacks. The upper portion of FIG. 2A illustrates a conventional false data injection attack that is detectable. In this scenario, Alice transmits observables to Mallory. Mallory performs a one-way attack by modifying the observables before forwarding the modified observables to Bob. Bob then sends a modified command back through Mallory to Alice. The result of this attack pattern is that unexpected behavior is observed, allowing the attack to be detected by the system. Detectable false data injection attacks are attacks in which a system observer can observe altered state behaviors due to the false data injection attack. This form of attack can be rejected or compensated through isolation of observed anomalies. Once an anomaly is identified and isolated, a fault can be triggered or the system states can be compensated as if the false data injection attack is a system disturbance.

The lower portion of FIG. 2A illustrates an intelligent false data injection attack (FDIA) that is undetectable. In this scenario, Alice again transmits observables to Mallory. However, Mallory performs a perfectly undetectable attack involving coordinated two-way manipulation, modifying both the observables sent to Bob and the commands returned to Alice. Mallory forwards modified observables to Bob, receives an unexpected command from Bob, and then transforms the unexpected command into an expected command before sending the expected command to Alice. The result of this coordinated manipulation is that the observed response appears expected from the controller's perspective, rendering the attack undetectable through conventional means.

An undetectable attack from the controller's perspective refers to an attack in which the presence of an attack cannot be determined based on plant observations. Under such an attack, the controller observes nominal initial conditions and dynamics. Stealthy attacks, which are synonymous with covert attacks as described herein, are a class of undetectable attacks where a detector is explicitly taken into account, ensuring that the attack does not set off an alarm or trigger. A more knowledgeable attacker can formulate a perfectly undetectable attack by choosing to manipulate communication in both directions. Perfectly undetectable attacks are those where there is no change in observed states at any time, but the system is still attacked. In the case of an undetectable attack, attacked signals coincide with those that are within regular operating range, thus conventional fault detection methods can fail to identify the intrusion.

The sequence diagram of FIG. 2A demonstrates the distinction between detectable attacks, where a single communication direction is compromised, and perfectly undetectable attacks, where coordinated manipulation of both command and observation channels masks the attack from the controller's perspective. This two-way attack architecture represents a threat model where the attacker leverages knowledge of the system dynamics to maintain mathematical consistency between the manipulated commands and observations.

For anomaly detection associated with false data injection attacks, a model-based control approach can be employed where the controller compares observed plant behaviors induced by control commands with those simulated based on a nominal plant dynamic model. Any discrepancies identified through this process can indicate potential false data injection, disturbances, or plant uncertainties. However, if the controller observes small changes under a detection threshold or no changes at all in the plant dynamics between normal and attacked states, model-based anomaly detection can be ineffective. Mitigation of undetectable attacks is difficult because observed states do not deviate from expected trajectories as in the detectable case. Detection through residuals such as probing signals can be ineffective because the controller observes the expected response since the controller perceives nominal dynamics.

FIG. 2B illustrates a block diagram of an affine transformation-based perfectly undetectable attack (ATPA) applied to a mobile robot control system. The diagram depicts the data flow and transformation operations that occur when an attacker intercepts and manipulates both control commands and state observations in a coordinated manner to remain undetectable from the controller's perspective. The affine transformation-based attack can be referred to herein as an affine transformation-based perfectly undetectable attack, ATPA, or simply an affine transformation-based attack.

In the affine transformation-based attack, an attacker who has gained access to a communication channel between a controller and a robot plant can intercept and modify signals in both directions: downstream from the controller to the robot and upstream from the robot to the controller. The affine transformation-based attack applies static attack parameters Sₓ, Sᵤ, dₓ, and dᵤ that define transformations of actuation commands and observation values. The parameters Sᵤ and Sₓ are transformation matrices, and dᵤ and dₓ are offset vectors.

The system receives a control command vector q consisting of linear velocity v and angular velocity ω from a legitimate controller. The control command enters a transformation block where the control command undergoes an affine transformation. The transformation involves multiplication by a scaling matrix Sᵤ followed by addition of an offset vector dᵤ, producing a manipulated command signal. Mathematically, the command transformation can be expressed as:

ũ=Sᵤ·u+dᵤ
where ũ represents manipulated commands, u represents the original control commands, Sᵤ is the transformation matrix for commands, and dᵤ is the offset vector for commands.

The manipulated command is fed into a mobile robot kinematics block, which implements the relationship between the time derivative of the robot position and the control input through a Jacobian matrix J that depends on the robot orientation θ_{c}. The robot state vector p_{c} contains the position coordinates x_{c} and y_{c} along with the orientation θ_{c}.

The state information flows through a second transformation block. The state transformation applies a scaling matrix Sₓ to the position vector and adds an offset vector dₓ, producing a manipulated state measurement that is transmitted back to the controller. The state transformation can be expressed as:

\tilde{x}=Sₓ·x+dₓ
where \tilde{x} represents manipulated state measurements, x represents the actual state measurements, Sₓ is the transformation matrix for states, and dₓ is the offset vector for states.

For the attack to remain undetectable, the following condition can be satisfied:

$${S}_{x} \cdot J ( {θ}_{c} ) \cdot {S}_{u} = J ( {θ}_{c}^{′} )$$

where J represents the Jacobian matrix mapping control commands to state derivatives, θ_{c} represents the current orientation, and θ′_{c} represents the observed orientation. This condition ensures that the dynamics observed by the controller match expected behavior despite the attack. The attacker coordinates the parameters of both transformations such that the dynamics observed by the controller match the expected nominal behavior of the robot, thereby achieving undetectability.

In a perfectly undetectable attack, the attacker applies coordinated transformations to both command signals and state measurements. For example, if a scaling transformation with factor β is applied to velocity commands (creating manipulated commands), a compensating transformation with factor 1/β can be applied to position measurements (creating manipulated measurements) to maintain mathematical consistency from the controller's perspective. Two specific types of perfectly undetectable false data injection attacks are possible using affine transformations: scaling attacks and reflection attacks. In a scaling attack, the attacker modifies the magnitude of commands and observations by coordinated scaling factors. In a reflection attack, the attacker applies sign changes to commands and observations in a coordinated manner.

The affine transformation-based attack offers a simpler attack structure compared to covert attacks. An attacker can inject false data via an affine transformation on both the plant's control commands and the observables. Given knowledge of the plant dynamics, the two affine attacks can be correlated such that the observable attack inverts the control attack's observable effect, thus concealing the attack from the defender across all time. The attacker can implement the attack with knowledge of the structure of the Jacobian matrix J and initial conditions, without requiring knowledge of the geometries of the mobile robot, mechanical details such as wheel size, tread length, inertia, chassis material, or center of gravity, or details implemented in the controller such as the tracking controller type or gains.

The affine transformation-based attacks exploit the multi-dimensional nature of robotic systems. By manipulating variables of the same physical quantities through operations such as scaling or reflection, attackers can alter a robot's behavior while maintaining mathematical consistency. The preservation of mathematical structures in multi-dimensional spaces poses challenges for traditional detection methods.

To detect affine transformation-based attacks, the disclosed technology employs a non-equivariant state monitoring signature function. As described above, the motion control unit processes the state measurements through the non-equivariant state monitoring signature function to compute a first signature value. The non-equivariant state monitoring signature function is configured such that no transformation exists that can simultaneously transform both the state measurements and the first signature value while maintaining mathematical consistency. The non-equivariant state monitoring signature function is configured to detect affine transformation-based attacks that apply coordinated transformations to both control commands and state measurements. When an attacker attempts to apply a transformation to manipulate state measurements, the attacker cannot apply a corresponding transformation to the signature value that would preserve the expected relationship. By computing signature values at both the robot plant and the remote controller and comparing the values, the system can detect transformation-based attacks that would otherwise remain undetectable through conventional anomaly detection methods.

FIG. 2C illustrates a block diagram of a covert attack mechanism on a mobile robot control system. In contrast to the affine transformation-based attack described above, a covert attack incorporates a malicious controller, referred to as a covert agent or malicious controller, between a plant and a networked controller. The covert agent provides an alternate control objective while simultaneously inverting plant observables such that the legitimate controller does not observe anomalies. The covert attack can be referred to herein as a covert attack or a stealthy attack.

In the covert attack mechanism, a control command vector q consisting of linear velocity v and angular velocity @ enters the system from a legitimate controller. The control command vector is intercepted by a malicious covert agent that includes a first transformation function and a second transformation function. The first transformation function can be denoted as \tilde{Π}ᵤ, and the second transformation function can be denoted as Πᵤ. The first transformation function \tilde{Π}ᵤ processes incoming control commands based on an attacked model associated with a Jacobian matrix J that depends on an attacked orientation. The second transformation function Πᵤ processes the control commands based on an unattacked plant model.

The covert agent computes two disturbance variables μ and γ based on the attacked model and the unattacked plant model. A disturbance calculation block, denoted as Θ, computes a command modification variable μ based on an error between a reference disturbance γ_{ref} and an actual disturbance variable γ. An error calculation junction produces an error value ε by subtracting the disturbance variable γ from the reference disturbance γ_{ref}. The disturbance calculation block Θ processes the error value ε to generate the command modification variable μ.

A robot state vector p_{c} contains position coordinates x_{c} and y_{c} along with an orientation θc. The robot state is affected by a manipulated command \tilde{q} sent to the robot. A second summing junction adds the command modification variable μ to the original control commands to produce the manipulated command \tilde{q}. The manipulated command \tilde{q} is processed through a mobile robot kinematics block that implements the relationship \dot{p}_{c}=J(θc)\tilde{q}, where J represents the Jacobian matrix that depends on the robot orientation θ_{c}.

A first summing junction subtracts the disturbance variable γ from actual robot state measurements to produce manipulated state measurements. The manipulated state measurement \tilde{p}_{c} is transmitted back to the controller, creating the illusion that the robot is following an intended trajectory. The covert agent maintains internal models of both attacked and unattacked plant dynamics to compute the appropriate disturbance variables that mask the attack from the controller's perspective.

The covert attack differs from the affine transformation-based attack in computational complexity. The affine transformation-based attack applies static attack parameters that define transformations of actuation commands and observation values. In contrast, the covert attack requires extensive computation and manipulation of the closed-loop system with complete knowledge of the plant dynamics. The covert attack requires computationally intensive operations involving polynomial expressions of encrypted values.

Monitoring the encrypted control commands for anomalous noise levels can be configured to detect covert attacks that implement a malicious controller between the robot system and the remote controller. While plaintext injected signals alone can bypass an overflow trap detection mechanism, the computation of the attack variable γ involves multiplicative operations between ciphertext values. The multiplicative operations between ciphertext values cause encryption noise to increase in a multiplicative fashion. For covert attack implementations, a degree d of operations satisfies d≥3 due to plant model computations, resulting in noise accumulation that exceeds ciphertext and plaintext thresholds. The covert attack detection relies on the fact that computation of the attack variable γ requires multiplicative operations between ciphertext values, causing significant noise accumulation.

In unencrypted systems, covert attacks can be implemented without generating detectable computational artifacts. The overflow trap provides a detection mechanism specific to encrypted control architectures. The encryption overflow trap can detect covert attacks by leveraging noise growth characteristics of homomorphic encryption, where higher-order polynomial operations accumulate encryption noise beyond detection thresholds.

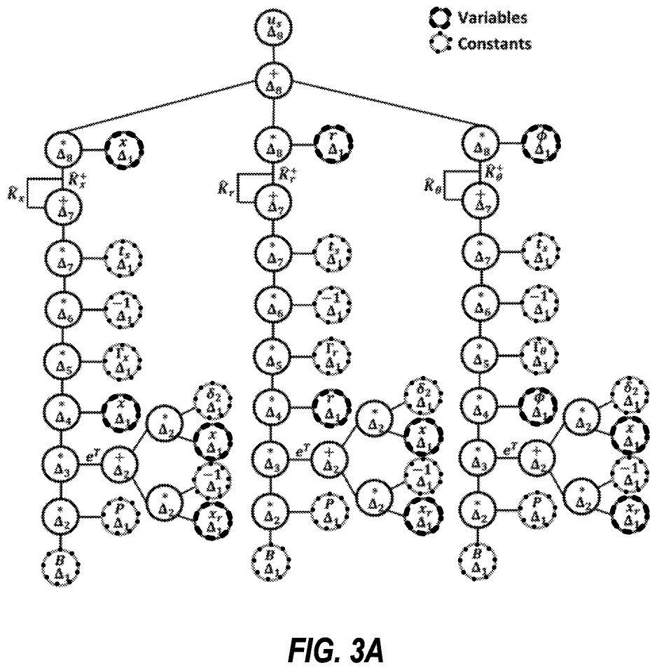

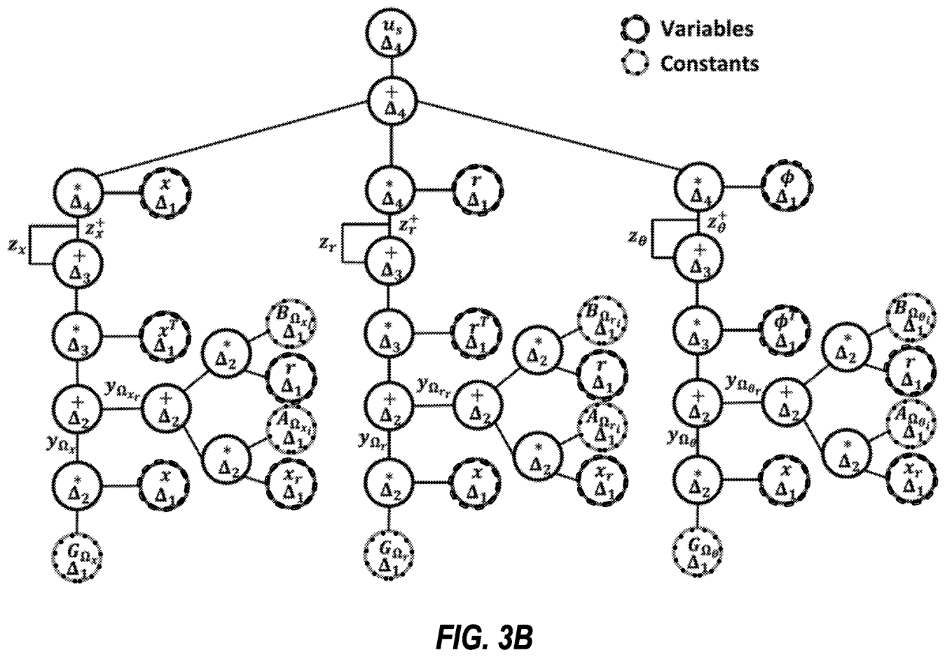

FIG. 3A illustrates a computational graph representation of a control command calculation for a mobile robot system. The computational graph depicts a hierarchical structure of mathematical operations used to compute a composite control signal. The computational graph can be used to analyze the encryption depth of control algorithms when implemented with homomorphic encryption schemes.

In the computational graph of FIG. 3A, a final output control command is positioned at the top of the graph. The output node connects downward to an addition operation node, which combines three parallel computational branches. Each of the three branches corresponds to a different state variable component, with a first branch associated with a state feedback component, a second branch associated with a reference input component, and a third branch associated with a basis function component.

Within each branch, a series of addition and multiplication operations are arranged in a descending tree structure. The nodes can be distinguished by visual representation, where solid-bordered circles indicate variables and dashed-bordered circles indicate constants. Each computational node can be labeled with either an addition or multiplication symbol along with a depth subscript indicating the computational depth level. The depth subscripts range from a first depth level at the bottom to an eighth depth level at the top for an unmodified model reference adaptive control (MRAC) implementation.

The three branches share common structural elements including multiplication nodes at various levels, constant nodes containing values such as negative one, time-related parameters, position offsets, and scaling factors. At the bottom of each branch, base input values feed into the computation. Intermediate nodes include references to exponential terms, position parameters, and coordinate transformation factors that are combined through the multiplication and addition operations to produce the final control command components.

The computational graph of FIG. 3A represents an unmodified MRAC algorithm structure. The arithmetic circuit of this unmodified framework reaches a maximum encryption depth of eight. Implementation of this algorithm with a somewhat homomorphic encryption scheme can require encryption parameters of large size, depending on the given system. The encryption parameters can reach bit sizes that create challenges for practical implementation due to the large encryption parameters required to prevent overflow.

FIG. 3B illustrates a computational graph representation of encrypted control operations for a mobile robot system. The computational graph of FIG. 3B shows a modified algorithm structure that achieves a reduced encryption depth compared to the unmodified implementation of FIG. 3A.

In the computational graph of FIG. 3B, three parallel computational branches converge to produce output values. Each branch processes different combinations of state variables and constants through multiplication and addition operations. A first branch processes variables related to a first spatial coordinate, beginning with state variable and constant inputs at a bottom level that feed into multiplication operations at a second level. The multiplication results combine through addition operations at a third level, which then feed into further multiplication operations at a fourth level, ultimately contributing to a final output value.

A second branch follows a similar structure, processing variables related to a second spatial coordinate and angular orientation. State variables and constants enter at the bottom level, undergo multiplication at the second level, combine through addition at the third level, and proceed through multiplication at the fourth level before contributing to the output.

A third branch processes angular state variables and orientation-related constants, following the same hierarchical pattern of multiplication and addition operations across four levels before producing a contribution to the final output.

The computational graph of FIG. 3B distinguishes between two types of nodes using different visual representations: solid-line circles represent variables that change during system operation, while dashed-line circles represent constants that remain fixed throughout the computation. Each node can be labeled with a subscript indicating the computational depth level within the graph hierarchy.

The three branches share a common output node at the top of the graph, where individual computational results combine to produce the final encrypted control output. This structure represents the polynomial operations required for implementing encrypted trajectory tracking control.

The depth of the computational graph directly relates to the encryption noise accumulation that enables the overflow trap detection mechanism. In homomorphic encryption schemes, mathematical operations performed on encrypted data cause noise to accumulate within ciphertext. Complex operations such as multiplication cause more noise growth than simple operations such as addition. The encryption depth, denoted as d, represents the maximum number of sequential multiplication operations in the computational graph.

A depth-compressed implementation can reduce encryption depth from d=8 to d=4. This reduction in encryption depth enables a reduction in encryption key length from approximately 7415 bits to approximately 1027 bits. The depth-compressed implementation achieves this reduction by reformulating the control algorithm such that constants are grouped via matrix manipulation and algorithm constraints before encryption. The grouped constants form a modified state space that remains encrypted in a cloud computing environment during algorithm execution.

The modified state space formulation reduces the control law's depths by grouping constants that would otherwise require sequential multiplication operations. By pre-computing and grouping constant matrices, the number of encrypted multiplication operations performed during each control cycle can be reduced. The reduced encryption depth translates directly to reduced computational overhead and improved real-time performance of the encrypted control system while preserving the security benefits of the overflow detection mechanism.

The relationship between encryption depth and the overflow trap detection mechanism can be understood as follows. For a general polynomial with ζ inputs up to degree d, an upper bound of the polynomial can be estimated as (ζ+1)^{d}M^{d}, where M represents the maximum expected plaintext value. This upper bound is used to determine encryption parameters that prevent overflow during normal operation. When an attacker attempts to perform polynomial operations on encrypted control commands, the operations can cause noise accumulation that exceeds the predetermined thresholds, enabling detection of the attack.

For the depth-compressed implementation with d=4, the encryption parameters can be tuned to detect attacks that perform polynomial operations of degree two or greater on the encrypted control commands. The overflow trap leverages the fact that covert attacks require computationally intensive operations involving polynomial expressions of encrypted values, which cause significant noise accumulation. Affine transformation-based attacks, which perform first-order transformations, do not accumulate encryption noise and thus are not detected by the overflow trap. The non-equivariant state monitoring signature function complements the overflow trap by detecting affine transformation-based attacks.

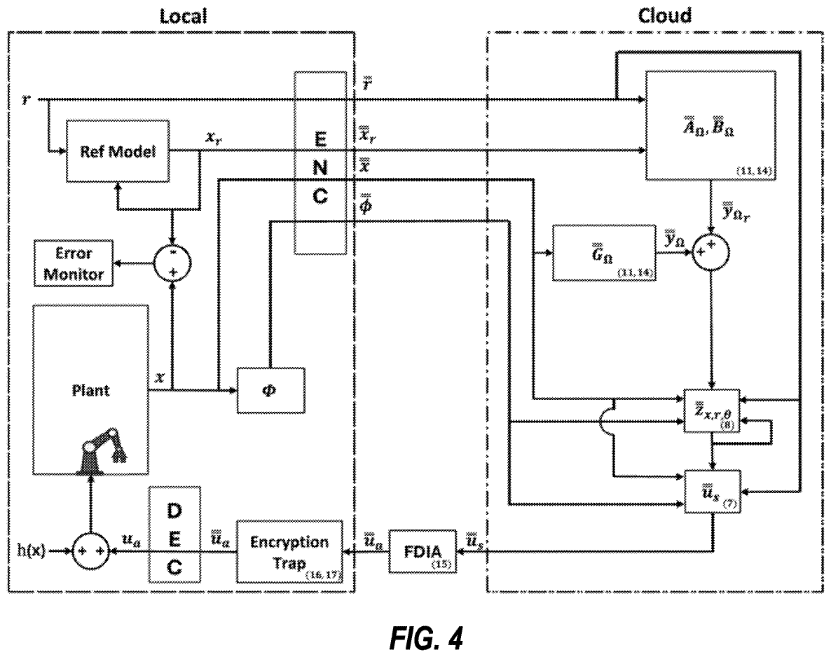

FIG. 4 illustrates a combined defense architecture for an encrypted telerobotic control system according to examples of the disclosed technology. The system architecture is divided into two regions: a local region and a cloud region. The local region contains components associated with the robot plant, while the cloud region contains components associated with the remote controller that operates on encrypted data.

The local region, which corresponds to the robot plant and motion control unit, includes a plant that represents the physical robot system. The plant receives control inputs and produces state outputs based on the robot dynamics. A reference model receives a reference input and generates a reference state that represents the desired behavior of the system. An error monitor compares the reference state with a current state to detect discrepancies between intended and actual behavior.

The local region further includes an encoder that encrypts state information for transmission to the cloud region. The encoder receives the current state from the plant and a signature function output. A non-equivariant state monitoring signature function processes the current state to generate a monitoring value. The non-equivariant state monitoring signature function can be referred to herein as a signature function or SMSF. The motion control unit can process the state measurements through the non-equivariant state monitoring signature function to compute a first signature value. The encoder encrypts both the state measurements and the first signature value for secure transmission via the communication network.

A decoder in the local region receives encrypted control commands from the cloud region and decrypts the commands for application to the plant. An encryption trap module monitors the decrypted commands for signs of false data injection attacks. The encryption trap module can be referred to herein as an encryption overflow detection module. The encryption overflow detection module is configured to monitor the encrypted control commands for anomalous noise levels and generate an alert responsive to detecting noise levels exceeding a predetermined threshold.

The cloud region contains an encrypted controller and an encrypted state observer that operate on encrypted data without requiring decryption. The encrypted state observer processes encrypted state information and reference state data to compute encrypted control commands. The encrypted controller uses encrypted system matrices to generate appropriate control signals. A summing junction combines the encrypted observer output with an encrypted reference to produce a final encrypted control command.

At the remote controller, the system can receive the first signature value and the state measurements from the motion control unit. The remote controller can process the received state measurements through the non-equivariant state monitoring signature function to compute a second signature value. A signature verification module compares the first signature value with the second signature value to detect transformation-based attacks. When a difference between the first signature value and the second signature value exceeds a predefined threshold, the system can generate an alert indicating a potential affine transformation-based attack.

The remote controller can encrypt control commands using homomorphic encryption. The encrypted control commands are transmitted to the motion control unit via the communication network. The encryption overflow detection module monitors the encrypted control commands for anomalous noise levels indicative of unauthorized manipulation. The system can generate an alert responsive to at least one of: a difference between the first signature value and the second signature value exceeding a predefined threshold, or the encrypted control commands exhibiting anomalous noise levels.

The two defense mechanisms operate in parallel within the combined architecture. The non-equivariant state monitoring signature function targets affine transformation-based attacks by ensuring that any attempt to apply the same transformation to both state measurements and signature values creates detectable inconsistencies. The encryption overflow trap targets covert attacks that require computationally intensive operations involving polynomial expressions of encrypted values, which cause noise accumulation that exceeds detection thresholds.

The non-equivariant state monitoring signature function can be implemented as a polynomial function. Polynomial signature functions can be evaluated within homomorphic encryption without decryption, thus complementing the encrypted system requirement of the overflow trap. This characteristic allows the signature function computation to be performed in the cloud region on encrypted data, maintaining data confidentiality while enabling signature verification.

The data flow within the combined architecture proceeds as follows. State measurements flow from the plant through the encoder to the cloud region. The encoder encrypts the state measurements along with the signature value computed by the signature function. In the cloud region, the encrypted controller performs homomorphic computations on the encrypted data to generate encrypted control commands. The encrypted control commands are transmitted back to the local region through the decoder. The decoder decrypts the commands, and the encryption trap monitors for anomalous values before the commands are applied to the plant actuators.

A false data injection attack block in FIG. 4 represents a potential attacker who can attempt to manipulate the encrypted control signals. The encryption trap is positioned to detect such attacks by monitoring whether ciphertext values exceed normal operation ranges. Covert attacks that require polynomial operations on encrypted data cause encryption noise to increase in a multiplicative fashion, resulting in noise accumulation that exceeds ciphertext and plaintext thresholds.

By implementing both the non-equivariant state monitoring signature function and the encryption overflow trap in parallel, the combined architecture provides protection against different categories of undetectable attacks. The non-equivariant state monitoring signature function can detect affine transformation-based attacks, while the encryption overflow trap can detect covert attacks. Both mechanisms can be applied simultaneously without interfering with each other, and the combined approach can provide detection capability with reduced false positive rates.

The non-equivariant state monitoring signature function can be designed as a polynomial function of state variables of the robot system. The polynomial function can be configured to be asymmetric, injective, nonlinear, and noninvertible. These properties contribute to the effectiveness of the signature function in detecting transformation-based attacks.

A function φ(x) is non-equivariant with respect to a transformation Γₓ if no transformation Γ_{φ} exists such that:

Γ_{φ}(φ(x))=φ(Γₓ·x) for all x

Equivalently, the function φ(x) is non-equivariant if there exist states x₁ and x₂ such that:

φ(x₁)=φ(x₂)butφ(Γₓ·x₁)≠φ(Γₓ·x₂)

This condition guarantees that any attempt to transform both the robot state and the signature function output using the same transformation parameters creates detectable inconsistencies.

The design of effective non-equivariant polynomial functions can follow several principles. The polynomial function can include terms of different degrees to ensure non-equivariance with respect to scaling transformations. Including terms of different degrees, such as quadratic, cubic, and quartic terms, breaks homogeneity of the function. The non-equivariant state monitoring signature function can comprise a polynomial function including terms of at least two different degrees.

The polynomial function can include odd-powered terms to ensure sensitivity to sign changes from reflection transformations. Odd-powered terms such as cubic terms change sign when input variables are negated, enabling detection of reflection attacks that apply sign changes to commands and observations in a coordinated manner.

The polynomial function can include coupled terms between different state variables to ensure non-equivariance with respect to permutation transformations. Coupled terms introduce asymmetry between variables, preventing attackers from permuting state variables without creating detectable changes in the signature value.

For mobile robot security applications, a quartic signature function can be defined as:

φ(x,y)=x⁴+y⁴+(x−50xy)²+(xy−5y)²

This function expands to:

φ(x,y)=x⁴+y⁴+x²+25y²−100x²y−10xy²+2501x²y²

The quartic signature function includes terms of different degrees, including quadratic terms (x², y²), cubic terms (x²y, xy²), and quartic terms (x⁴, y⁴, x²y²). The mixed-degree polynomial structure ensures that no equivariant transformation Γ_{φ} can exist that would allow an attacker to mask the transformation of the state. The quartic signature function is non-equivariant with respect to both scaling and reflection transformations.

For detecting permutation attacks in a three-dimensional system, a cubic signature function based on complex roots of unity can be defined as:

φ(x,y,z)=x³+(−½)y³+(−½)z³+(\sqrt{3}/2)(y³−z³)

The cubic signature function is derived from a complex-valued function using the primitive cube root of unity ω=e^{2πi/3}=−½+i√3/2, expressed in real numbers. The cubic signature function maps permutations of the input variables to outputs with equal distances between the outputs, enabling detection and classification of permutation attacks. The cubic signature function preserves the property of mapping permutations of variables to distinct outputs while maintaining equal distances between those outputs.

A kernel analysis method can be used to find violation pairs that demonstrate non-equivariance. The kernel of the output function q provides a source of states with identical outputs. The kernel analysis method involves computing the kernel of the signature function and checking if the transformation preserves the kernel. For a non-zero vector v in the kernel of φ, if φ(Γₓ·v)≠0, then (0, v) is a violation pair. Alternatively, for distinct vectors v₁ and v₂ in the kernel of φ, if φ(Γₓ·v₁)≠φ(Γₓ·v₂), then (v₁, v₂) is a violation pair. The kernel analysis method is effective for linear systems.

A differential approach can be used to find violation pairs by analyzing level sets of the signature function and checking gradient conditions. For smooth functions φ and transformations Γₓ, the differential approach leverages differential geometry to find violation pairs. A level set L_{y} of φ corresponding to output y is defined as the set of all x such that φ(x)=y. If there exist x₁ and x₂ in the same level set L_{y} such that:

∇φ(Γₓ·x₁)·(Γₓ·x₁−Γₓ·x₂)≠0
then no equivariant transformation Γ_{φ} exists. The gradient ∇φ at a point is perpendicular to the level set at that point. If two points lie on the same level set, the vector connecting the two points is tangent to the level set. The differential approach extends naturally to nonlinear smooth functions.

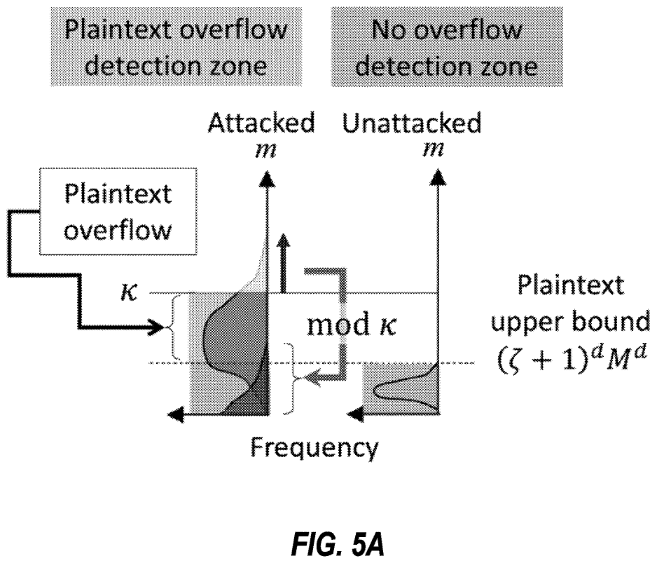

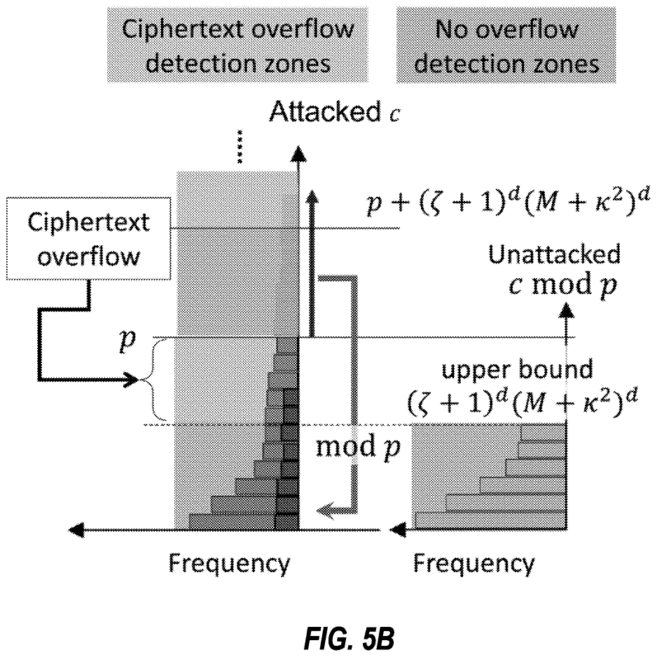

FIG. 5A illustrates plaintext overflow detection in an encrypted control system under attack conditions according to examples of the disclosed technology. The diagram depicts a plaintext overflow detection zone and a no overflow detection zone, demonstrating how the encryption overflow trap can detect false data injection attacks by monitoring plaintext values after decryption operations.

The encryption overflow trap operates by determining encryption parameters for homomorphic encryption based on a maximum expected plaintext value and a maximum degree of operations to be performed in the control system. The encryption parameters can be selected by first determining a largest algorithm plaintext value X including total scaling factors. A minimum bit size b can be determined to represent the value X according to b=log₂(X+1), and a maximum expected plaintext value M can be found according to M=2^{b}−1.

In FIG. 5A, the vertical axis represents a message value m, with the horizontal axis representing frequency. The diagram distinguishes between two zones: a plaintext overflow detection zone on the left side and a no overflow detection zone on the right side. A plaintext upper bound is expressed as (ζ+1)^{d}·M^{d}, where ζ represents a number of variables in the control algorithm, d represents a maximum degree of operations to be performed, and M represents the maximum expected plaintext value. This upper bound defines the threshold above which plaintext values indicate a potential attack.

The diagram shows frequency distributions for both attacked and unattacked message values. The unattacked message distribution remains within the no overflow detection zone, below the plaintext upper bound. The attacked message distribution extends into the plaintext overflow detection zone, where values exceed the expected operating range.

During decryption, a modulo κ operation is applied to the ciphertext values. The parameter k represents a secret key component that satisfies the plaintext bound condition. The modulo κ operation wraps values that exceed κ back into a lower range. FIG. 5A illustrates this modulo κ operation with a curved arrow showing how values wrap around during decryption.

The plaintext overflow detection mechanism operates as follows. When an attacker implements an attack that pushes a ciphertext value into the plaintext overflow space, the defender can detect the attack as a value larger than allowed. The plaintext overflow condition can be expressed as:
where ūₐ represents a potentially attacked encrypted control command, p represents a ciphertext modulus parameter, and κ represents the plaintext modulus parameter.

Determining encryption parameters can comprise determining a value κ that satisfies κ>(ζ+1)^{d}M^{d}, where ζ is the number of variables, d is the maximum degree of operations, and M is the maximum expected plaintext value. The value κ can be selected as a prime number larger than the minimum value calculated from this bound.

If an attack pushes the ciphertext value above κ, the modulo κ operation can return the plaintext value to below (ζ+1)^{d}M^{d}, which can result in an undetectable attack according to the plaintext overflow detection condition. The encryption parameters can be tuned to maximize the probability that attacked values fall within the detectable overflow region while maintaining normal operation for unattacked values.

The encryption overflow detection module can monitor a noise characteristic of the encrypted control commands. The noise characteristic can comprise a remaining noise budget of the encrypted control commands. The detection module can calculate a detection probability based on the noise characteristic and generate an alert responsive to the detection probability exceeding a predefined threshold, wherein the alert indicates a potential false data injection attack.

The plaintext overflow detection mechanism complements the ciphertext overflow detection mechanism described with reference to subsequent figures. Both mechanisms operate in parallel to monitor the encrypted control commands for anomalous noise levels indicative of unauthorized manipulation. The plaintext overflow detection targets attacks that cause values to exceed the plaintext upper bound after the modulo p operation but before the modulo κ operation, while the ciphertext overflow detection targets attacks that cause values to exceed the ciphertext upper bound before the modulo p operation.

FIG. 5B illustrates ciphertext overflow detection zones and frequency distributions for attacked and unattacked ciphertext values according to examples of the disclosed technology. The diagram depicts the relationship between ciphertext values and frequency distributions, demonstrating how the encryption overflow trap can detect false data injection attacks by monitoring ciphertext values before modulo operations are applied during decryption.

In FIG. 5B, a vertical axis represents an attacked ciphertext value c, while a horizontal axis represents frequency. The diagram distinguishes between ciphertext overflow detection zones and no overflow detection zones. A ciphertext upper bound is expressed as (ζ+1)^{d}(M+κ²)^{d}, where ζ represents a number of variables in the control algorithm, d represents a maximum degree of operations to be performed, M represents a maximum expected plaintext value, and κ represents a plaintext modulus parameter. This ciphertext upper bound defines the threshold above which ciphertext values indicate a potential attack during normal operation.

The diagram shows frequency distributions for both attacked and unattacked ciphertext values. The unattacked ciphertext distribution remains within the no overflow detection zone, below the ciphertext upper bound (ζ+1)^{d}(M+κ²)^{d}. The attacked ciphertext distribution extends into the ciphertext overflow detection zone, where values exceed the expected operating range. A curved arrow in FIG. 5B illustrates a mod p operation that wraps values around during decryption, where p represents a ciphertext modulus parameter.

The ciphertext overflow detection mechanism operates as follows. When an attacker implements an attack that pushes a ciphertext value into the ciphertext overflow space, the defender can detect the attack as a value larger than allowed. The ciphertext overflow condition can be expressed as:
where ūₐ represents a potentially attacked encrypted control command, p represents the ciphertext modulus parameter, ζ is the number of variables, d is the maximum degree of operations, Mis the maximum expected plaintext value, and κ is the plaintext modulus parameter.

Determining encryption parameters can comprise determining a value p that satisfies p>(ζ+1)^{d}(M+κ/2)^{d}. The value p can be selected as a prime number larger than the minimum value calculated from this bound. The remote controller can encrypt control commands using the homomorphic encryption with the determined encryption parameters. The encrypted control commands can be transmitted via a communication network to a robot system. The robot system can receive the encrypted control commands at the robot system for decryption and application to actuators.

If an attack pushes the ciphertext value above p, the mod p operation can return the ciphertext value to below (ζ+1)^{d}(M+κ²)^{d}, which can result in an undetectable attack according to the ciphertext overflow detection condition. However, the encryption parameters can be tuned to maximize the probability that attacked values fall within the detectable overflow region while maintaining normal operation for unattacked values.

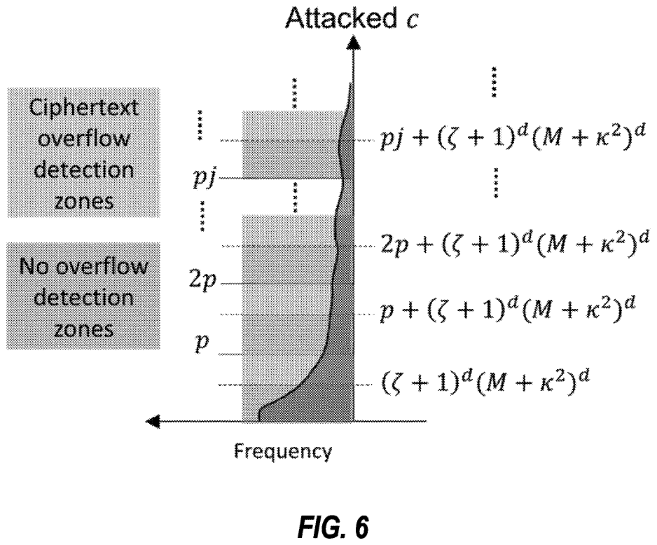

FIG. 6 illustrates a relationship between attacked ciphertext values and frequency distribution in ciphertext overflow detection zones according to examples of the disclosed technology. The diagram depicts multiple detection zones that arise when attacked ciphertext values exceed multiples of the ciphertext modulus parameter p.

In FIG. 6, a vertical axis represents an attacked ciphertext value c, while a horizontal axis represents frequency. The diagram shows multiple horizontal threshold levels that define different operational zones. At a base level, a threshold labeled as (ζ+1)^{d}(M+κ²)^{d} establishes the upper bound for normal operation without overflow. Above this base threshold, additional thresholds at values of p, 2p, and jp define boundaries between successive detection zones, where p represents the ciphertext modulus parameter and j represents an integer multiplier.

Each threshold level is offset by the base overflow bound, creating a repeating pattern of detection zones. The ciphertext overflow detection zones appear between each multiple of p and the next threshold defined by the sum of that multiple and the overflow bound. The no overflow detection zones appear in the regions between the overflow bound and the next multiple of p.

A frequency distribution curve is superimposed on the graph of FIG. 6, showing the statistical distribution of attacked ciphertext values across the detection zones. The distribution indicates that attacked values tend to cluster in patterns that can extend into the overflow detection regions. The probabilistic detection of ciphertext overflow can be expressed as:

This expression represents the probability that an attacked ciphertext value falls within one of the ciphertext overflow detection zones. The probabilistic detection of ciphertext overflow can be expressed as the ratio of the detection zone width to the total ciphertext space. The probability can be approximated as:

$${P}_{pp} \approx \frac{p - {( ζ + 1 )}^{d} {( M + {κ}^{2} )}^{d}}{p}$$

The ciphertext overflow detection is performed synchronously with the encryption at each sampling period using new noise for each encryption. The overall probability of attack detection over ξ iterations during which a false data injection attack is imposed can be expressed as:

The encryption parameter p can be manipulated to maximize the detection probability such that false data injection attack detection is achieved as quickly as possible without negatively impacting performance. Increasing the bit length λ of the encryption parameter p stretches the ciphertext overflow detection zones, thereby increasing the probability that attacked values fall within detectable regions. The cumulative detection probability over ξ iterations can be expressed as:

P_{ξ}=1−(1−Pₚₚ)^{ξ}

The ciphertext overflow detection mechanism complements the plaintext overflow detection mechanism described above. Both mechanisms operate in parallel to monitor the encrypted control commands for anomalous noise levels indicative of unauthorized manipulation. The plaintext overflow detection targets attacks that cause values to exceed the plaintext upper bound after the mod p operation but before the mod κ operation, while the ciphertext overflow detection targets attacks that cause values to exceed the ciphertext upper bound before the mod p operation. By implementing both detection mechanisms, the system can provide probabilistic detection of attacks that cause excessive noise accumulation in the homomorphic encryption scheme.

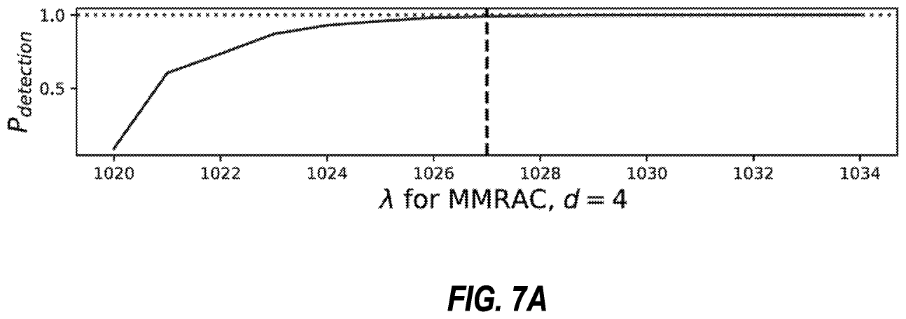

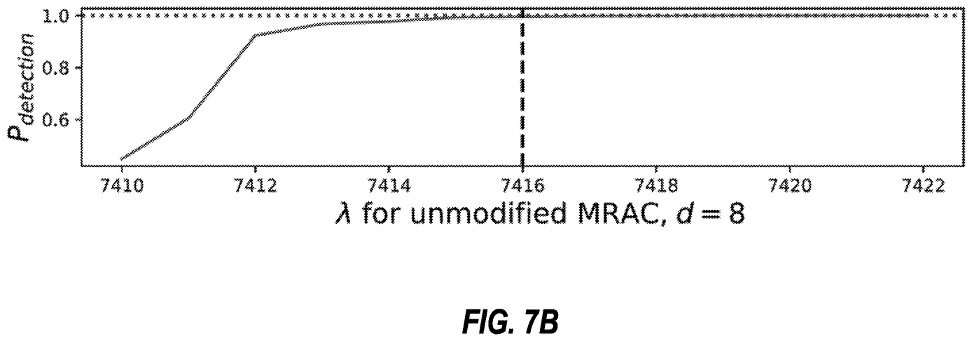

FIG. 7A illustrates a graph of detection probability as a function of an encryption parameter λ for a depth-compressed model reference adaptive control implementation according to examples of the disclosed technology. The depth-compressed implementation operates with an encryption depth d=4. In FIG. 7A, a horizontal axis represents the encryption parameter λ ranging from approximately 10²⁰ to 10³⁴, while a vertical axis represents detection probability P ranging from 0.5 to 1.0. A solid curved line shows the detection probability increasing from a lower value near 0.5 at λ values around 10²⁰, rising steeply through the range of approximately 10²² to 10²⁴, and then leveling off to approach a value of 1.0 as A increases beyond approximately 10²⁶. A horizontal dashed line is positioned at a detection probability of 1.0, representing a target threshold. A vertical dashed line intersects the horizontal axis at approximately λ=10²⁷, indicating a parameter value where the detection probability reaches or closely approaches the maximum value.

FIG. 7B illustrates a graph of detection probability as a function of an encryption parameter λ for an unmodified model reference adaptive control implementation according to examples of the disclosed technology. The unmodified implementation operates with an encryption depth d=8. In FIG. 7B, a horizontal axis represents λ values ranging from approximately 74¹⁰ to 74²², while a vertical axis represents detection probability P ranging from approximately 0.6 to 1.0. A solid curve illustrates the detection probability as a function of λ, showing a steep increase from lower detection probability values around λ=74¹⁰ to higher detection probability values approaching 1.0 as λ increases beyond approximately 74¹⁶. A horizontal dashed line indicates a detection probability threshold at approximately 1.0, and a vertical dashed line marks a specific λ value at approximately 74¹⁶ where the detection probability curve transitions from rapid increase to a plateau near the maximum detection probability.

The relationship between encryption parameters and detection probability can be understood through the noise budget characteristics of homomorphic encryption schemes. As described above, the encryption overflow detection module can monitor a noise characteristic of the encrypted control commands. The noise characteristic can comprise a remaining noise budget of the encrypted control commands. Monitoring the encrypted control commands for anomalous noise levels can comprise calculating a detection probability based on a remaining noise budget of the encrypted control commands, comparing the detection probability to a detection threshold, and determining that anomalous noise levels are present responsive to the detection probability exceeding the detection threshold.

For a BFV encryption scheme, the detection probability can be calculated according to:
where Bₘₐₓ is a maximum noise budget for a fresh ciphertext, B_{remaining} is a current noise budget, and γ is a sensitivity parameter. The detection probability increases as the remaining noise budget decreases. When an attacker performs polynomial operations on encrypted control commands, the operations consume noise budget, causing B_{remaining} to decrease and the detection probability to increase correspondingly.

For a BGV encryption scheme, the detection probability can use a modified exponent according to:

The modified exponent of 1.5 reflects the different noise growth patterns during operations in the BGV scheme compared to the BFV scheme.

For a CKKS encryption scheme, a scale-based detection approach can be used. The CKKS scheme does not provide a direct noise budget measure, so the detection probability can be calculated according to:

where s is a current scale of the ciphertext, s_{expected} is an expected scale based on the operations performed, γ is a sensitivity parameter, and a is a scale factor that adjusts the detection probability based on the encryption level.

The encryption overflow trap relies on random noise added during encryption, providing probabilistic rather than deterministic attack detection. The overall probability of detecting an attack over multiple iterations can be given by:
where ξ is a number of iterations or samples examined. This formula gives the probability of detecting the attack at least once in ξ iterations. The cumulative detection probability P_{ξ} approaches 1.0 as the number of iterations increases, providing near-certainty of attack detection within a small number of iterations while maintaining negligible false positive rates during normal operation.

The encryption parameters can be tuned to achieve a target detection probability. The encryption parameters can be tuned such that detection probability P≈99.99% with encryption parameters λ=550, ρ=32, and ρ′=125. With this tuning, detections are unlikely to result in false positives unless the system operates outside of expected operating states.

The depth-compressed implementation with d=4 can achieve near-perfect detection around λ=1027 bits, while the unmodified implementation with d=8 can achieve near-perfect detection around λ=7415 bits. The depth-compressed implementation reduces required key lengths by approximately 86% while maintaining equivalent detection capability. The reduced key length requirements translate directly to reduced computational overhead and improved real-time performance of the encrypted control system while preserving the security benefits of the overflow detection mechanism.

The encryption overflow detection module can be configured to calculate a detection probability based on a remaining noise budget of the encrypted control commands. The detection module can generate an alert responsive to the detection probability exceeding a predefined threshold, wherein the alert indicates a potential false data injection attack. The method can be configured to detect attacks that perform polynomial operations of degree two or greater on the encrypted control commands. Affine transformation-based attacks, which perform first-order transformations, do not accumulate encryption noise and thus are not detected by the overflow trap. The non-equivariant state monitoring signature function complements the overflow trap by detecting affine transformation-based attacks.

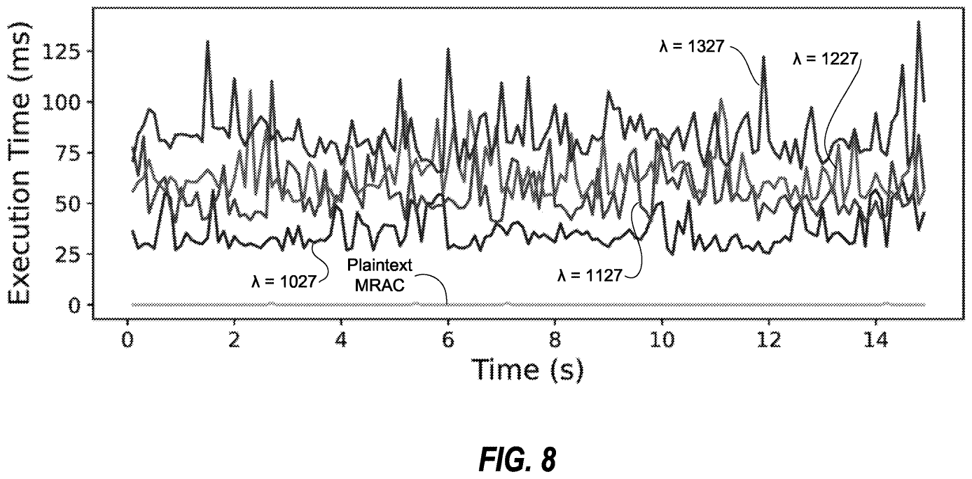

FIG. 8 illustrates execution time as a function of time for different encryption parameter configurations according to examples of the disclosed technology. The graph depicts execution time in milliseconds on a vertical axis and time in seconds on a horizontal axis, with the horizontal axis ranging from 0 to approximately 14 seconds and the vertical axis ranging from 0 to approximately 125 milliseconds.

FIG. 8 shows multiple traces corresponding to different values of the encryption parameter λ, including λ=1027, λ=1127, λ=1227, and λ=1327, along with a trace representing a plaintext model reference adaptive control (MRAC) implementation. The plaintext MRAC trace maintains a relatively constant low execution time near the bottom of the graph throughout the time period, demonstrating minimal computational overhead for unencrypted control operations.

The encrypted implementations with varying λ values exhibit higher and more variable execution times compared to the plaintext implementation. The trace corresponding to λ=1027 shows moderate variability in execution time, while the traces for λ=1127, λ=1227, and λ=1327 demonstrate progressively higher execution times with increased variability. The graph illustrates the computational overhead associated with encrypted control implementations compared to plaintext implementations.

The relationship between the encryption parameter λ and execution time can be characterized as follows. The average execution time for plaintext MRAC and the execution times for encrypted implementations with increasing λ values by 100 bits can be approximately 0.098 ms, 35.18 ms, 52.45 ms, 68.46 ms, and 85.33 ms, respectively. Execution time and λ can display a linear relationship, with larger 2 values resulting in correspondingly longer execution times.

For real-time operability of encrypted control systems, execution times can remain below 100 ms per control loop iteration. The lower λ values utilized in the depth-compressed implementation can remain in an operable range for real-time control applications. The higher λ values can reach above the 100 ms threshold, which can impact real-time performance.

The depth-compressed implementation with encryption depth d=4 can operate with λ=1027 bits while maintaining execution times suitable for real-time control. In contrast, an unmodified implementation with encryption depth d=8 can require λ=7410 bits for proper security and overflow prevention. By interpolation of the linear relationship between execution time and λ, an estimated execution time per iteration for λ=7410 can be approximately 1 second. The unmodified encrypted implementation with d=8 can provide even slower iterations due to an increased number of encrypted operations, resulting in estimated execution times significantly greater than 1 second per iteration.

The depth-compressed implementation can maintain real-time integrity without unreasonably large ciphertext values. The reduced encryption depth from d=8 to d=4 enables a reduction in encryption key length from approximately 7415 bits to approximately 1027 bits, which translates directly to reduced computational overhead and improved real-time performance of the encrypted control system while preserving the security benefits of the overflow detection mechanism.

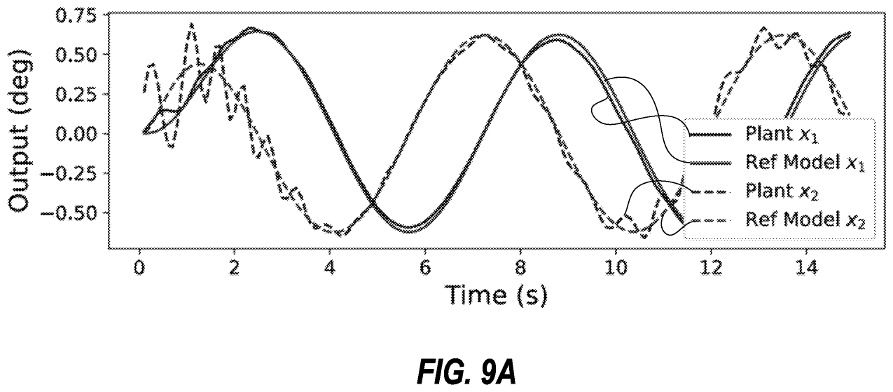

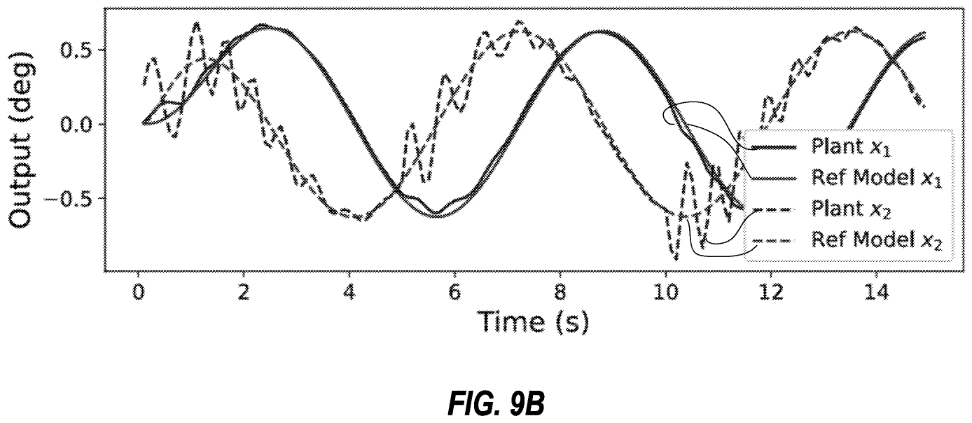

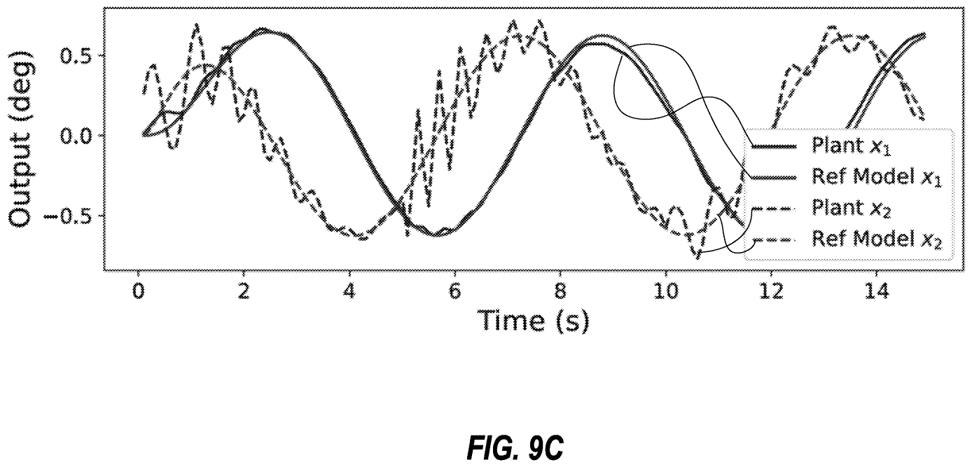

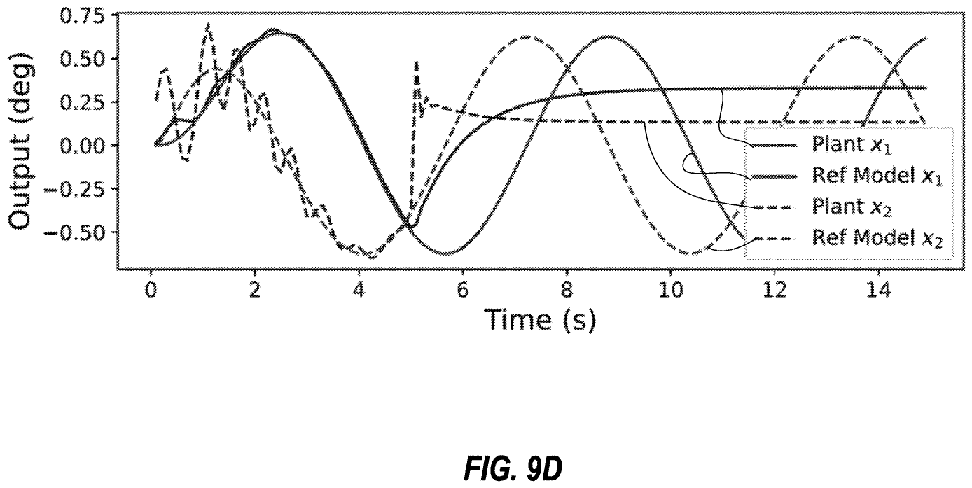

FIG. 9A through FIG. 9D illustrate output measurements for a mobile robot trajectory tracking control system under various conditions according to examples of the disclosed technology. The figures depict plant state tracking performance relative to reference model states over a time period of approximately 14 to 15 seconds, with output measurements expressed in degrees.

FIG. 9A illustrates tracking performance in a scenario with no attack present in the system. In FIG. 9A, a horizontal axis represents time in seconds, and a vertical axis represents output in degrees ranging from approximately −0.50 to 0.75 degrees. Four traces are displayed: a first solid line representing a first plant state x₁, a first dashed line representing a first reference model state x₁, a second solid line representing a second plant state x₂, and a second dashed line representing a second reference model state x₂. The plant states closely track the reference model states throughout the measurement period. The traces demonstrate oscillatory behavior, with the plant states converging toward and following the reference model trajectories. The close correspondence between plant states and reference model states indicates tracking performance of the encrypted control system under normal operating conditions without attack interference.

FIG. 9B illustrates output measurements for the mobile robot trajectory tracking control system under a second condition. In FIG. 9B, the horizontal axis represents time in seconds, and the vertical axis represents output in degrees with a similar range to FIG. 9A. The graph contains four traces representing plant states and reference model states for the first and second state variables. The plant outputs track the reference model outputs, with some visible deviation in the middle portion of the time range. The tracking behavior demonstrates that the adaptive control algorithm can compensate for certain types of perturbations while maintaining plant state convergence toward the reference model trajectories.

FIG. 9C illustrates output measurements for the mobile robot trajectory tracking control system under a third condition. In FIG. 9C, the traces exhibit oscillatory behavior over the time period, with the plant responses tracking the reference model responses. The oscillations show varying amplitudes throughout the measurement period, with deviations occurring at certain time intervals where the plant and reference model traces temporarily diverge before reconverging. The tracking performance demonstrates that the control system can adapt to perturbations and maintain reference model tracking despite the presence of disturbances.

FIG. 9D illustrates output measurements for the mobile robot trajectory tracking control system under attack conditions. In FIG. 9D, the horizontal axis represents time ranging from 0 to 14 seconds, and the vertical axis represents output in degrees ranging from approximately −0.50 to 0.75 degrees. Four curves are displayed representing plant states x₁ and x₂ along with reference model states x₁ and x₂. The curves demonstrate oscillatory behavior over time, with the plant states and reference model states showing varying degrees of tracking performance. The first state variable pair exhibits larger amplitude oscillations compared to the second state variable pair. The graph illustrates the dynamic response of the control system under attack conditions, showing how the plant outputs track the reference model outputs with deviations visible between the plant and reference model trajectories throughout the time period.

The tracking performance across the four scenarios can be characterized as follows. In scenarios without attacks or with low-order perturbations such as additive attacks or first-order multiplicative attacks, the adaptive control algorithm can absorb the disturbances and maintain plant state tracking of the reference model. The adaptive law compensates for injected bias or gain variations, and the plant state remains close to the reference model throughout the measurement period. In scenarios with higher-order attacks such as second-order multiplicative attacks, the plant state can diverge from the reference model, and the encryption overflow trap can detect the attack based on anomalous noise levels in the encrypted control commands.

The distinction between detectable and non-detectable attacks through the overflow trap mechanism relates to the degree of polynomial operations performed on the encrypted control commands. Attacks of degree zero or degree one do not accumulate encryption noise beyond detection thresholds and can be compensated by the adaptive control algorithm. Attacks of degree two or greater cause encryption noise to increase in a multiplicative fashion, resulting in noise accumulation that exceeds ciphertext and plaintext thresholds. The overflow trap can distinguish degree-two or greater attacks from degree-one or lesser attacks based on whether the encrypted control commands exhibit anomalous noise levels.

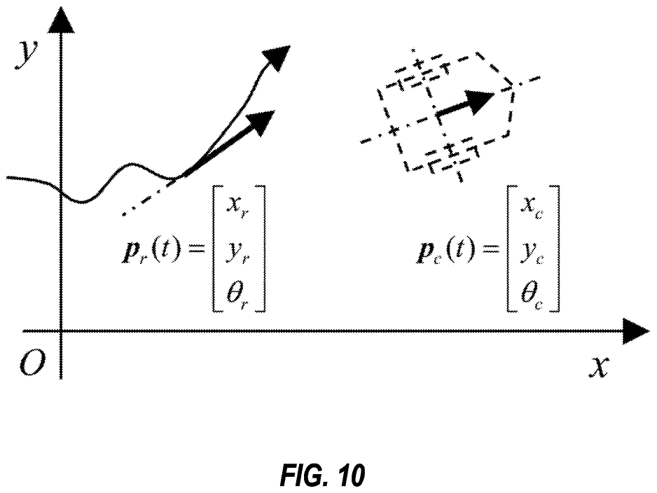

FIG. 10 illustrates mobile robot trajectory tracking with reference and current postures according to examples of the disclosed technology. FIG. 10 depicts a two-dimensional coordinate system with a horizontal x-axis and a vertical y-axis intersecting at an origin O. A curved solid line represents a reference trajectory path extending through the coordinate plane.

A reference posture pᵣ(t) is indicated along the reference trajectory, with an arrow showing a direction of motion. The reference posture pᵣ(t) can be defined as a vector containing a reference x-position xᵣ, a reference y-position yᵣ, and a reference orientation angle θᵣ. A current posture p_{c}(t) is shown offset from the reference trajectory, depicted with a dashed rectangular outline representing a mobile robot body and an arrow indicating a current heading direction. The current posture p_{c}(t) can be defined as a vector containing a current x-position x_{c}, a current y-position y_{c}, and a current orientation angle θ_{c}.

As described above, the robot plant can comprise at least one of an industrial manipulator or a mobile robot. In some cases, the robot system can comprise a mobile robot with non-holonomic constraints. A mobile robot with non-holonomic constraints can be moved in two degrees of freedom despite having a three-degree-of-freedom position representation. The non-holonomic constraints restrict the mobile robot to move along a direction defined by the current orientation angle θ_{c}, such that the mobile robot cannot translate sideways without first changing orientation.

The mobile robot can follow a unicycle motion model. In the unicycle motion model, a control command vector q consists of a linear velocity v and an angular velocity @ in the mobile robot's local coordinate frame. The dynamics of the mobile robot can be expressed as a first-order nonlinear equation:
where J represents a Jacobian matrix that maps the control command q onto the time derivative of the position vector p_{c}. The Jacobian matrix J can be expressed as:

The Jacobian matrix J exhibits a block-diagonal structure, with the (3,1) element being constant and decoupled from the (1,1) and (2,1) elements. This structure indicates that the orientation angle θ_{c} of the mobile robot is governed by a first-order linear equation that depends on the angular velocity input ω.

A trajectory tracking controller can receive as inputs the reference posture pᵣ and the current posture p_{c}. An error posture pe can be computed based on a rotation matrix applied to the difference between the reference posture pᵣ and the current posture p_{c}. The trajectory tracking controller can generate the control command vector q based on the error posture pe and reference velocities computed from the reference trajectory. The trajectory tracking controller can drive the mobile robot from the current posture toward the reference posture along the reference trajectory.

In some implementations, the robot system can be a Turtlebot3 mobile robot with a Raspberry Pi3 single-board computer (SBC) as an onboard processor using the unicycle motion model. Communication between the mobile robot and a remote controller can use ROS2 middleware with multicast user datagram protocol (UDP) for communication among nodes. An attacker with privileged access to the network can intercept and modify traffic transmitted via the multicast UDP communication.

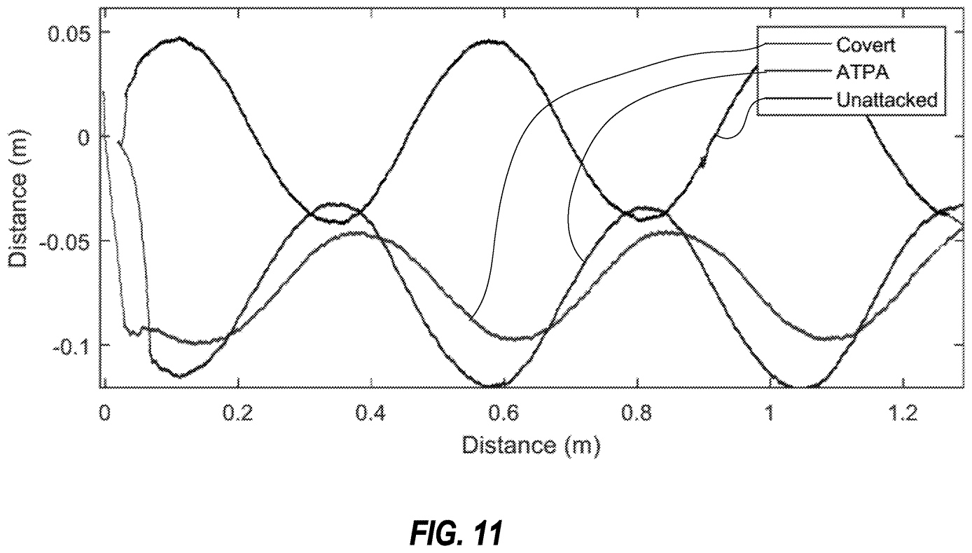

FIG. 11 illustrates mobile robot trajectories under different attack conditions according to examples of the disclosed technology. FIG. 11 depicts a graph with a horizontal axis representing distance in meters and a vertical axis representing distance in meters. Three distinct trajectory curves are shown corresponding to three different operational conditions: an unattacked trajectory, an affine transformation-based perfectly undetectable attack (ATPA) trajectory, and a covert attack trajectory.

The unattacked trajectory follows a sinusoidal path oscillating between positive and negative vertical positions as the mobile robot travels along the horizontal distance. The unattacked trajectory represents the nominal behavior of the mobile robot when no false data injection attack is present. The desired trajectory can be a sinusoidal movement across an approximately 1.2 meter space.

The affine transformation-based attack trajectory closely follows the unattacked trajectory. The affine transformation-based attack trajectory demonstrates that the affine transformation-based attack produces a path that appears nearly identical to normal operation from the controller's perspective. As described above, the affine transformation-based attack applies coordinated transformations to both control commands and state measurements. The affine transformation-based attack can be implemented with attack parameters to reflect the state trajectory about the initial orientation θ_{c}(0). From the controller's perspective, movement under the affine transformation-based attack matches the unattacked scenario due to the undetectability of the attack.

The covert attack trajectory shows a reflected or inverted sinusoidal pattern compared to the unattacked trajectory. The covert attack causes the mobile robot to deviate from the intended path while the controller observes nominal behavior. The covert attack implements a malicious controller between the plant and the networked controller, providing an alternate control objective while simultaneously inverting plant observables such that the legitimate controller does not observe anomalies.

The trajectories intersect at multiple points along the horizontal axis. The intersections occur at positions where the sinusoidal paths cross. The graph demonstrates the physical manifestation of undetectable false data injection attacks on mobile robot trajectory tracking control. Both the ATPA and the covert attack cause the actual robot position to differ from the intended trajectory while maintaining mathematical consistency from the controller's perspective.

The trajectory comparison of FIG. 11 illustrates the vulnerability of mobile robot trajectory tracking control systems to undetectable attacks. Conventional residual-based attack detection approaches can compare a current error profile during a potential attack with an averaged nominal error profile to detect statistical anomalies. However, the differences between average correlation values among trials can be statistically insignificant for both ATPA and covert attack comparisons relative to nominal operation. These findings demonstrate that conventional detection approaches can be ineffective for identifying undetectable attacks, motivating the use of the non-equivariant state monitoring signature function and the encryption overflow trap as complementary defense mechanisms.

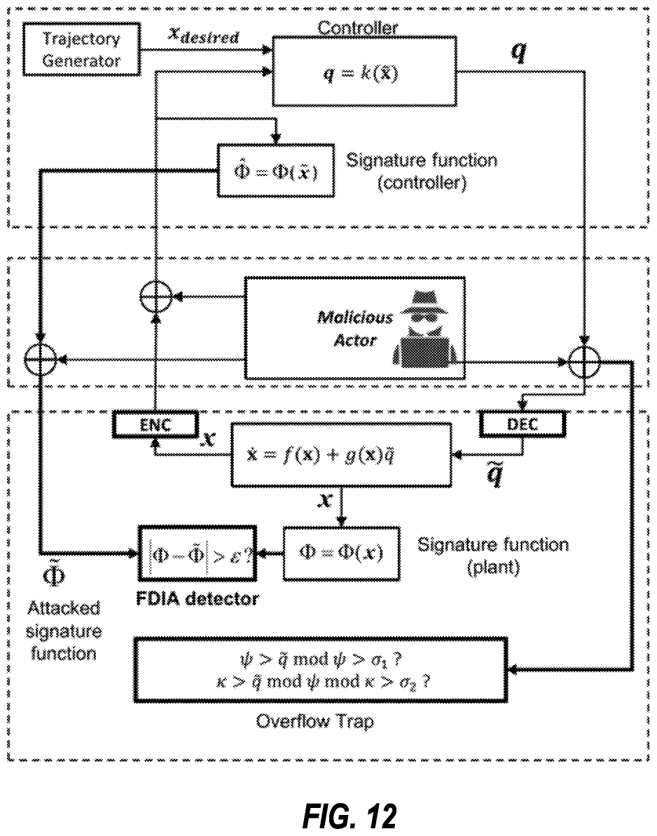

FIG. 12 illustrates a block diagram of a combined defense architecture for detecting false data injection attacks according to examples of the disclosed technology. The system architecture depicts the integration of two complementary attack detection mechanisms working in conjunction with encryption to protect against undetectable cyberattacks.

An upper portion of the diagram shows a controller section enclosed within a dashed boundary. The controller section includes a trajectory generator that provides a desired trajectory signal to a controller block. The controller block computes control commands as a function of an observed state. The controller section also includes a signature function block that computes a signature value based on the observed state. The signature function block can be referred to herein as a non-equivariant state monitoring signature function. The signature function block represents the controller-side implementation of the state monitoring signature function.

A malicious actor block is positioned between the controller section and a plant section. The malicious actor block represents an attacker capable of intercepting and manipulating signals in both directions. The malicious actor receives control commands from the controller and state measurements from the plant. Summing junctions on either side of the malicious actor block indicate points where false data can be injected into communication channels.

A lower portion of the diagram shows the plant section, also enclosed within a dashed boundary. The plant section includes encryption and decryption blocks that process signals entering and leaving the plant. Plant dynamics are represented by a state equation showing a time derivative of a state as a function of the state and a potentially attacked control command. An actual state is fed to a signature function block at the plant side that computes a signature value based on true state measurements.

A false data injection attack (FDIA) detector block compares the signature value computed at the plant with an attacked signature value received from the controller. The FDIA detector block can be referred to herein as a false data injection attack detector. When an absolute difference between the signature values exceeds a threshold, the FDIA detector identifies a potential affine transformation-based attack. The comparison of signature values enables detection of transformation-based attacks that apply coordinated transformations to both control commands and state measurements.

An encryption overflow detection module monitors encrypted control commands for anomalous noise levels. The encryption overflow detection module can also be referred to herein as an overflow trap block. The encryption overflow detection module evaluates conditions involving modulo operations with encryption parameters to detect when ciphertext values exceed normal operation ranges. When ciphertext values exceed predetermined thresholds, the encryption overflow detection module indicates potential covert attacks that involve polynomial operations on encrypted data.

The architecture demonstrates how the non-equivariant state monitoring signature function and the overflow trap operate in parallel. The signature function detects geometric transformation attacks by ensuring that any attempt to apply the same transformation to both state measurements and signature values creates detectable inconsistencies. The overflow trap detects computationally intensive attacks that accumulate encryption noise beyond detection thresholds.

Data flow within the combined architecture proceeds as follows. State measurements flow from the plant through an encoder to the controller. The encoder encrypts the state measurements along with the signature value computed by the signature function at the plant. At the controller, the controller block performs computations to generate control commands. The control commands are encrypted and transmitted back to the plant through a decoder. The decoder decrypts the commands, and the overflow trap monitors for anomalous values before the commands are applied to plant actuators.

The system can take different actions based on a type of attack detected. For attacks detected by the non-equivariant state monitoring signature function, the system can switch to a fail-safe mode or an alternative control strategy. For attacks detected by the overflow trap, the system can implement a backup controller or a safe shutdown procedure. The differentiated response enables the system to respond appropriately to different attack vectors based on the detection mechanism that identified the attack.

By implementing both the non-equivariant state monitoring signature function and the encryption overflow trap in parallel, the combined architecture provides protection against different categories of undetectable attacks. The non-equivariant state monitoring signature function can detect affine transformation-based attacks, while the encryption overflow trap can detect covert attacks. Both mechanisms can be applied simultaneously without interfering with each other, and the combined approach can provide detection capability with reduced false positive rates.

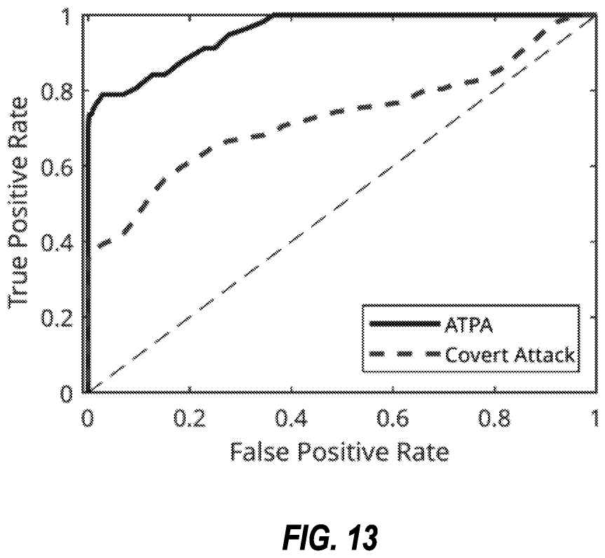

FIG. 13 illustrates a receiver operating characteristic (ROC) curve comparing detection performance of the non-equivariant state monitoring signature function under two attack scenarios according to examples of the disclosed technology. In FIG. 13, a horizontal axis represents a false positive rate ranging from 0 to 1, and a vertical axis represents a true positive rate ranging from 0 to 1. A diagonal dashed reference line represents random classification performance.

Two curves are displayed in FIG. 13. A first curve represents detection performance for affine transformation-based perfectly undetectable attacks (ATPA). The first curve rises steeply from the origin and maintains high true positive rates across false positive rate values, indicating that the non-equivariant state monitoring signature function can detect ATPA with high accuracy. The first curve achieves an area under the curve (AUC) of approximately 0.88.

A second curve represents detection performance for covert attacks. The second curve follows a more gradual trajectory that remains closer to the diagonal reference line, indicating that the non-equivariant state monitoring signature function has limited effectiveness in detecting covert attacks. The second curve achieves an AUC of approximately 0.65, which represents performance slightly better than random classification.

Based on analysis of the ROC curve, a detection threshold ε can be selected to achieve a target balance between true positive rate and false positive rate. In some implementations, a threshold of ε=2.87 can yield a true positive rate of 0.75 and a false positive rate of 0.01 for ATPA detection. The low false positive rate indicates that the non-equivariant state monitoring signature function can function as a strong classifier for detecting affine transformation-based attacks.

The performance differential illustrated in FIG. 13 demonstrates the complementary nature of the two defense mechanisms. The non-equivariant state monitoring signature function can detect affine transformation-based attacks with high accuracy but has limited effectiveness against covert attacks. The encryption overflow trap can complement the non-equivariant state monitoring signature function by detecting covert attacks that the signature function cannot reliably identify.

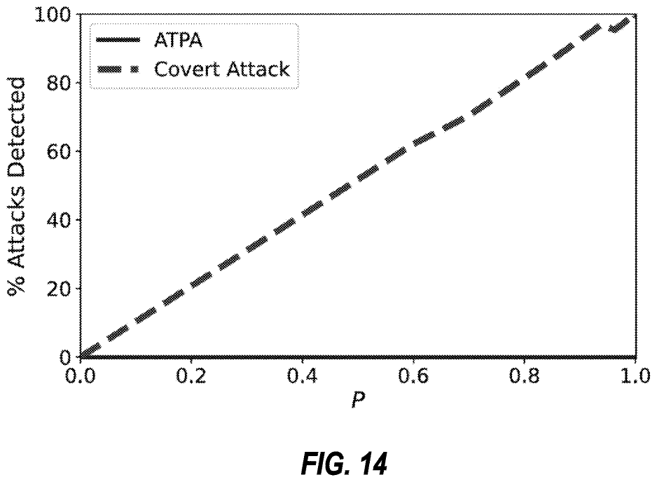

FIG. 14 illustrates a percentage of attacks detected as a function of a parameter P for two attack types according to examples of the disclosed technology. In FIG. 14, a horizontal axis represents the parameter P ranging from 0.0 to 1.0, and a vertical axis represents a percentage of attacks detected ranging from 0 to 100 percent. The parameter P represents a detection probability based on encryption parameter tuning.

A first curve in FIG. 14 represents detection performance for ATPA. The first curve remains constant at zero percent detection across all values of P, indicating that the encryption overflow trap does not detect affine transformation-based attacks regardless of the probability parameter setting. The ATPA performs first-order transformations that do not accumulate encryption noise beyond detection thresholds.

A second curve in FIG. 14 represents detection performance for covert attacks. The second curve shows a linear relationship between the parameter P and the percentage of attacks detected. The second curve starts at approximately zero percent when P equals zero and increases proportionally to reach approximately 100 percent detection when P equals 1.0. When the encryption overflow trap is tuned such that P≈99.99% with encryption parameters λ=550, ρ=32, and ρ′=125, the overflow trap can detect covert attacks throughout the attack duration.

The covert attack detection is realized due to higher-order transformations applied by the covert attack, which push encryption noise into overflow territory. The covert attack involves multiplicative operations between ciphertext values during computation of the attack variable γ, which causes encryption noise to increase in a multiplicative fashion. For covert attack implementations, a degree d of operations satisfies d≥3 due to plant model computations, resulting in noise accumulation that exceeds ciphertext and plaintext thresholds.

The detection performance illustrated in FIG. 13 and FIG. 14 demonstrates the complementary nature of the two defense mechanisms. The non-equivariant state monitoring signature function can detect affine transformation-based attacks with an AUC of 0.88, achieving a 75% true positive rate with a 1% false positive rate. The encryption overflow trap can detect covert attacks at 100% of the attack duration when tuned with appropriate encryption parameters, while detecting ATPA at a 0% rate due to minimal encryption noise introduced by affine transformations.

By implementing both the non-equivariant state monitoring signature function and the encryption overflow trap in parallel, the combined defense architecture can provide protection against different categories of undetectable attacks. The non-equivariant state monitoring signature function targets geometric transformation attacks, while the encryption overflow trap targets computationally intensive attacks that accumulate encryption noise. Both mechanisms can be applied simultaneously without interfering with each other, and the combined approach can provide detection capability across multiple attack vectors.

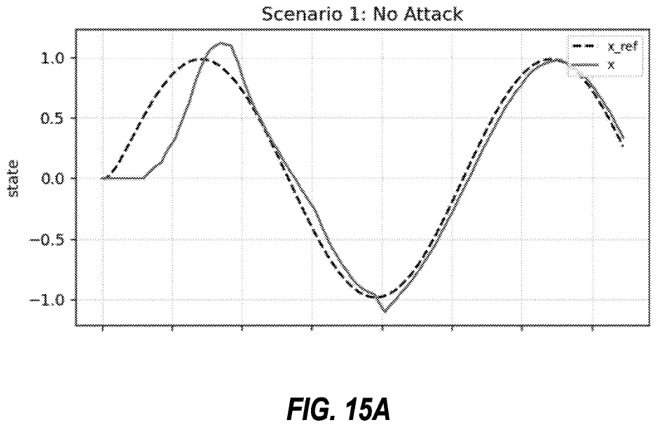

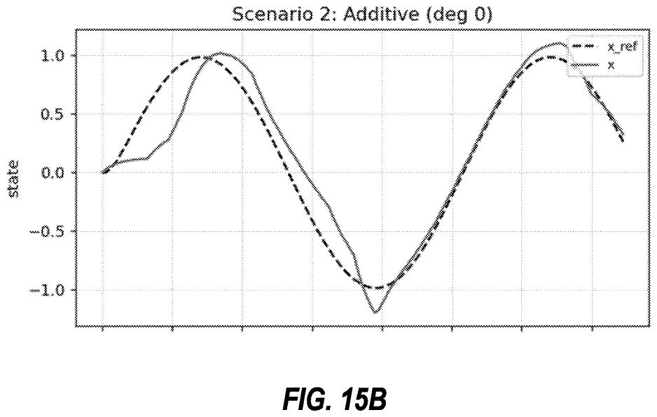

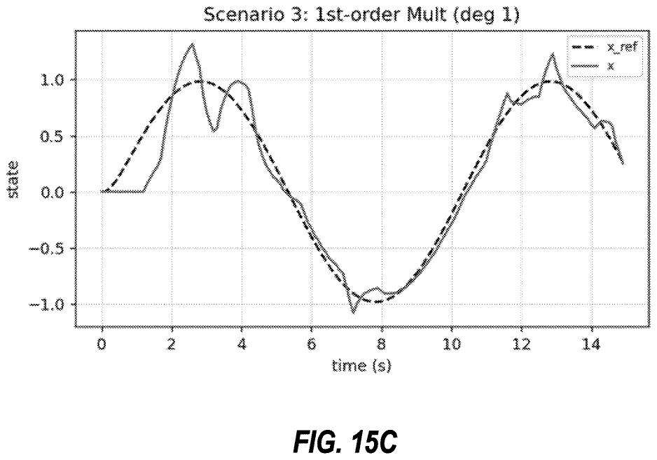

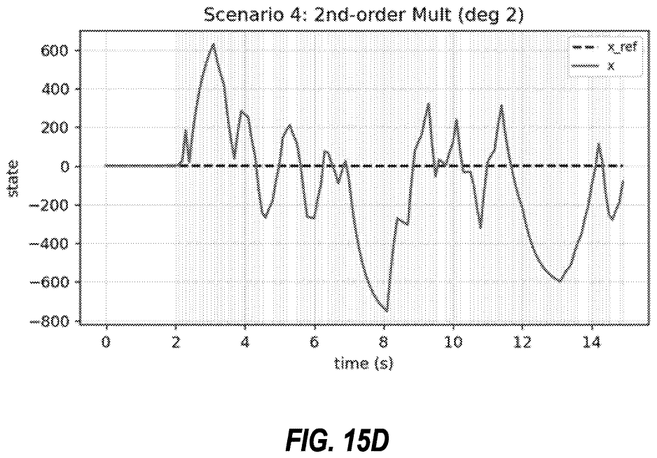

FIG. 15A through FIG. 15D illustrate state tracking performance under various attack scenarios according to examples of the disclosed technology. The figures depict plant state tracking performance relative to reference model states over a time period, demonstrating how tracking performance varies under different types of false data injection attacks.

FIG. 15A illustrates tracking performance in a scenario with no attack present in the system. In FIG. 15A, a horizontal axis represents time, and a vertical axis represents state values ranging from approximately negative one to positive one. A dashed line represents a reference trajectory x_{ref}, which follows a sinusoidal pattern oscillating between approximately positive one and negative one. A solid line represents an actual state trajectory x, which closely tracks the reference trajectory with minor deviations. Under normal operating conditions without any attack, the actual state trajectory follows the reference trajectory with small tracking errors, particularly visible during an initial transient phase where the solid line converges toward the dashed reference line. The close correspondence between the plant state and the reference model state indicates tracking performance of the control system under normal operating conditions without attack interference.

FIG. 15B illustrates state tracking performance under an additive attack scenario with degree zero. In FIG. 15B, a dashed line represents the reference trajectory x_{ref}, while a solid line represents the actual state trajectory x. The reference trajectory follows a sinusoidal pattern similar to FIG. 15A. The actual state trajectory generally follows the reference trajectory but exhibits deviations, particularly showing a phase lead at the beginning where the actual state rises before the reference, and slight amplitude differences throughout the tracking period. Despite the additive attack, the plant state continues to track the reference model. The additive attack can be expressed as an attack function that adds a constant offset to the control signal. A model reference adaptive control (MRAC) algorithm can absorb the degree-zero additive perturbation, causing the adaptive gains to drift to compensate for the injected bias while the plant state remains close to the reference model.

FIG. 15C illustrates tracking performance for a first-order multiplicative attack scenario with degree one. In FIG. 15C, a horizontal axis represents time ranging from zero to approximately fifteen seconds, while a vertical axis represents state values ranging from approximately negative one to positive one. A dashed line labeled x_{ref} represents the reference trajectory, and a solid line labeled x represents the actual measured state trajectory. The actual state trajectory generally follows the reference trajectory but exhibits oscillations and deviations, particularly visible as fluctuations around peaks and valleys of the reference signal. The actual state trajectory shows overshoot behavior near maximum values, where the solid line exceeds the dashed reference line. Despite the first-order multiplicative attack, the adaptive control algorithm can absorb the gain error introduced by the attack. The first-order multiplicative attack can be expressed as an attack function that multiplies the control signal by a time-varying coefficient. The MRAC adaptation compensates for the multiplicative perturbation, and the plant state remains close to the reference model throughout the measurement period.

FIG. 15D illustrates state tracking performance for a second-order multiplicative attack scenario with degree two. In FIG. 15D, a horizontal axis represents time in seconds, ranging from zero to approximately fourteen seconds. A vertical axis represents state values, ranging from approximately negative eight hundred to positive six hundred. A dashed horizontal line represents a reference state value x_{ref}, which remains constant at zero throughout the time period. A solid line represents the actual state value x, which exhibits significant oscillatory behavior with large amplitude variations over time. The actual state value x begins near zero at time zero, then shows increasing oscillations starting around time two seconds. The oscillations demonstrate irregular patterns with peaks reaching approximately six hundred and troughs extending to approximately negative eight hundred. The substantial deviation between the actual state x and the reference state x_{ref} indicates tracking performance degradation under the second-order multiplicative attack conditions.

The second-order multiplicative attack can be expressed as an attack function that includes a term proportional to the square of the control signal. The second-order nature of the attack pushes ciphertext values into an overflow space. The degree-two polynomial operations cause encryption noise to increase in a multiplicative fashion, resulting in noise accumulation that exceeds ciphertext and plaintext thresholds. The encryption overflow trap can detect the second-order multiplicative attack based on anomalous noise levels in the encrypted control commands.

The tracking performance across the four scenarios can be characterized as follows. In scenarios without attacks or with low-order perturbations such as additive attacks with degree zero or first-order multiplicative attacks with degree one, the adaptive control algorithm can absorb the disturbances and maintain plant state tracking of the reference model. The adaptive law compensates for injected bias or gain variations, and the plant state remains close to the reference model throughout the measurement period. The decrypted control signal stays inside a legitimate output band defined by predetermined thresholds.

In scenarios with higher-order attacks such as second-order multiplicative attacks with degree two, the plant state can diverge from the reference model. The encryption overflow trap can detect the attack based on anomalous noise levels in the encrypted control commands. The distinction between detectable and non-detectable attacks through the overflow trap mechanism relates to the degree of polynomial operations performed on the encrypted control commands. Attacks of degree zero or degree one do not accumulate encryption noise beyond detection thresholds and can be compensated by the adaptive control algorithm. Attacks of degree two or greater cause encryption noise to increase in a multiplicative fashion, resulting in noise accumulation that exceeds ciphertext and plaintext thresholds. The overflow trap can distinguish degree-two or greater attacks from degree-one or lesser attacks based on whether the encrypted control commands exhibit anomalous noise levels.

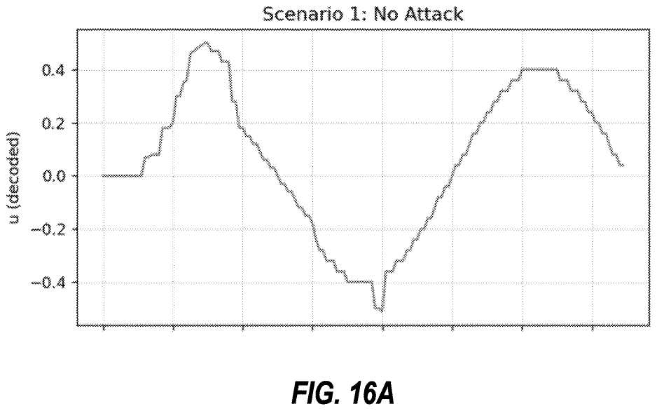

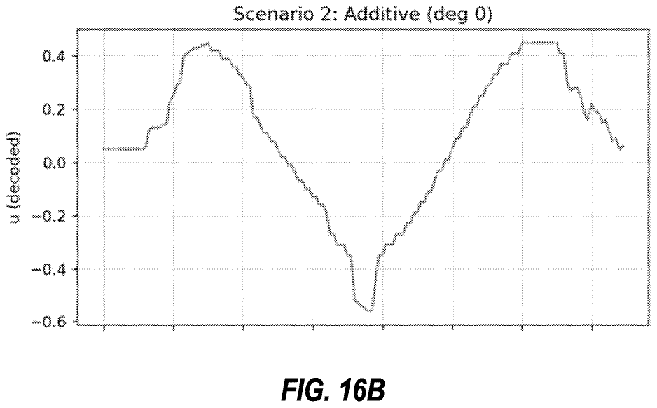

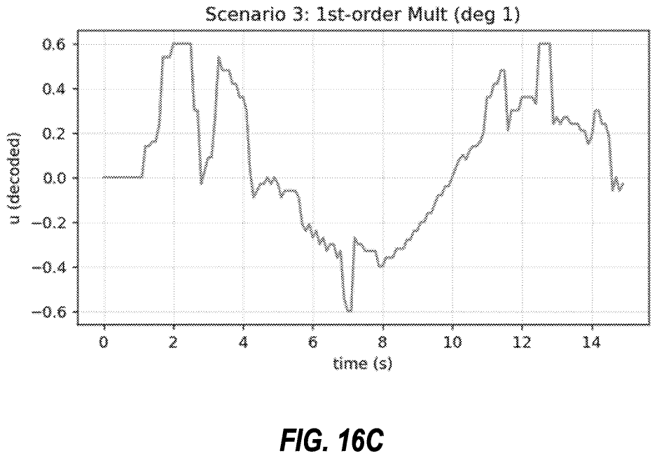

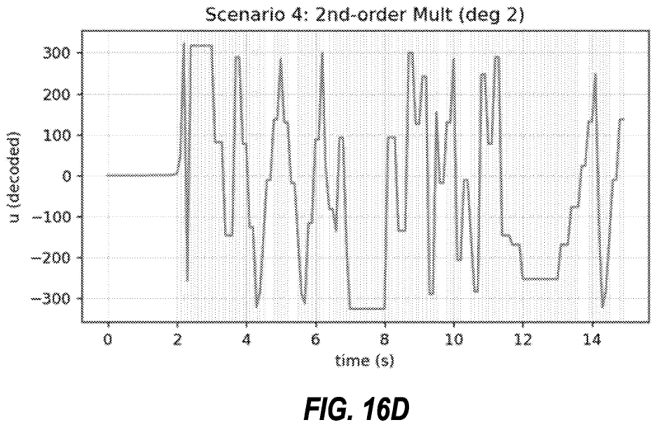

FIG. 16A through FIG. 16D illustrate decoded control signal values over time for various attack scenarios according to examples of the disclosed technology. The figures depict decoded control signal characteristics that correspond to the state tracking performance described above, demonstrating how control signals exhibit different behaviors under different types of false data injection attacks.

FIG. 16A illustrates decoded control signal values over time for a scenario with no attack present in the system. In FIG. 16A, a vertical axis represents a decoded control signal u, ranging from approximately negative 0.4 to positive 0.4. A horizontal axis represents time. A trace shows the control signal trajectory, which begins near zero, rises to a peak of approximately 0.5, descends through zero to a minimum of approximately negative 0.45, rises again to a second peak of approximately 0.4, and then begins to descend toward the end of the displayed time period. The waveform exhibits a generally sinusoidal pattern with some step-like variations characteristic of quantized or discretized signal processing. FIG. 16A represents baseline behavior of the control system operating under normal conditions without any false data injection attack, providing a reference for comparison with attacked scenarios.

FIG. 16B illustrates decoded control signal values over time for an additive attack scenario with degree zero. In FIG. 16B, a vertical axis represents the decoded control signal u with values ranging from approximately negative 0.6 to positive 0.4. A horizontal axis represents time. A trace illustrates temporal evolution of the decoded control signal. The signal begins at approximately 0.1, rises to a peak of approximately 0.4, then descends through zero to reach a minimum value of approximately negative 0.55, before rising again through zero to reach a secondary peak of approximately 0.35, and decreasing toward approximately 0.1 at the end of the displayed time period. The waveform exhibits a smooth, continuous pattern characteristic of a sinusoidal or quasi-periodic signal with some asymmetry between positive and negative excursions. Despite the additive attack, the decoded control signal remains within bounded ranges similar to the no-attack scenario of FIG. 16A. The additive attack can be expressed as an attack function that adds a constant offset to the control signal. A model reference adaptive control (MRAC) algorithm can absorb the degree-zero additive perturbation, causing adaptive gains to drift to compensate for injected bias while the decoded control signal remains within physically reasonable ranges.

FIG. 16C illustrates decoded control signal values over time for a first-order multiplicative attack scenario with degree one. In FIG. 16C, a horizontal axis represents time in seconds, ranging from zero to approximately fifteen seconds. A vertical axis represents the decoded value of u, ranging from approximately negative 0.6 to positive 0.6. A continuous trace shows temporal evolution of the decoded signal. The signal begins near zero at time zero, rises to approximately 0.5 around time two seconds, then decreases and oscillates between approximately 0.2 and 0.5 until around time four seconds. The signal then drops, reaching a minimum value of approximately negative 0.55 around time seven seconds. Following the minimum, the signal gradually increases, returning to positive values around time nine seconds and reaching a local maximum of approximately 0.6 around time twelve seconds. The signal subsequently decreases again, dropping to approximately negative 0.1 by time fifteen seconds. The first-order multiplicative attack can be expressed as an attack function that multiplies the control signal by a time-varying coefficient. Despite the first-order multiplicative attack, the adaptive control algorithm can absorb the gain error introduced by the attack. The MRAC adaptation compensates for the multiplicative perturbation, and the decoded control signal remains within bounded ranges throughout the measurement period.

FIG. 16D illustrates decoded control signal values over time for a second-order multiplicative attack scenario with degree two. In FIG. 16D, a horizontal axis represents time in seconds, ranging from zero to approximately fourteen seconds. A vertical axis represents the decoded control input u, ranging from approximately negative 300 to positive 300. A waveform begins near zero and remains relatively flat until approximately one second, after which the waveform exhibits significant oscillatory behavior with varying amplitudes. The waveform shows multiple peaks reaching values near 300 and troughs descending to approximately negative 300, with oscillations occurring at irregular intervals throughout the time period. The signal demonstrates complex dynamics with rapid transitions between positive and negative values, characteristic of a system under a second-order multiplicative attack condition.

The decoded control signal characteristics across the four scenarios can be characterized as follows. In scenarios without attacks or with low-order perturbations such as additive attacks with degree zero or first-order multiplicative attacks with degree one, the decoded control signal remains within bounded ranges that are physically reasonable for actuator operation. The decoded control signal stays inside a legitimate output band defined by predetermined thresholds. The adaptive law compensates for injected bias or gain variations, and the control signal maintains characteristics suitable for physical actuator operation.

In scenarios with higher-order attacks such as second-order multiplicative attacks with degree two, the decoded control signal exhibits large-magnitude excursions that exceed physically reasonable ranges. The large-magnitude excursions in FIG. 16D can saturate physical actuators. The second-order multiplicative attack can be expressed as an attack function that includes a term proportional to the square of the control signal. The second-order nature of the attack pushes ciphertext values into an overflow space, causing the decoded control signal to exhibit values that are distinguishable from legitimate computations.

The distinction between the decoded control signal characteristics in FIG. 16A through FIG. 16C compared to FIG. 16D relates to the degree of polynomial operations performed on the encrypted control commands. Attacks of degree zero or degree one do not accumulate encryption noise beyond detection thresholds and produce decoded control signals that remain within bounded ranges. Attacks of degree two or greater cause encryption noise to increase in a multiplicative fashion, resulting in decoded control signals that exhibit large-magnitude excursions outside legitimate output bands. The encryption overflow trap can distinguish degree-two or greater attacks from degree-one or lesser attacks based on whether the decoded control signals exhibit values outside predetermined thresholds.

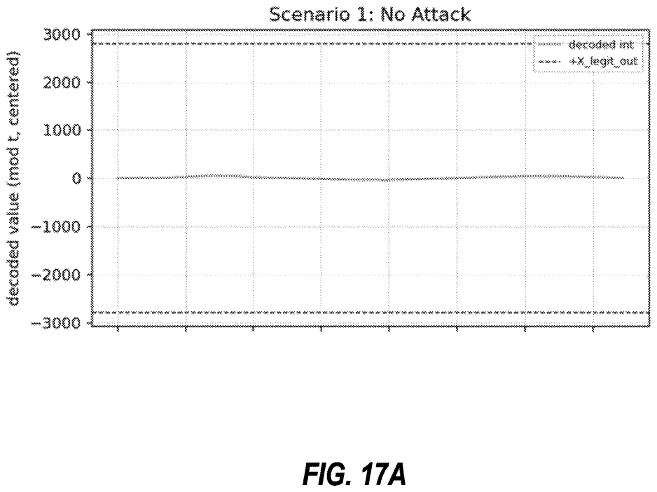

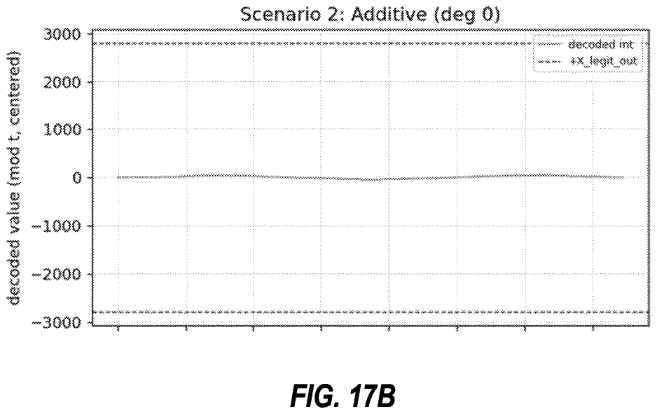

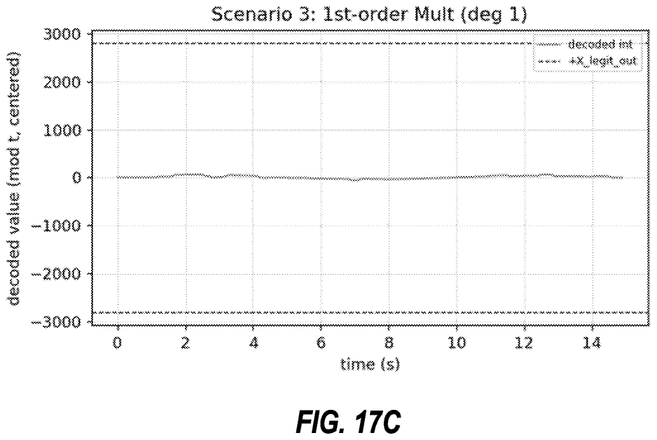

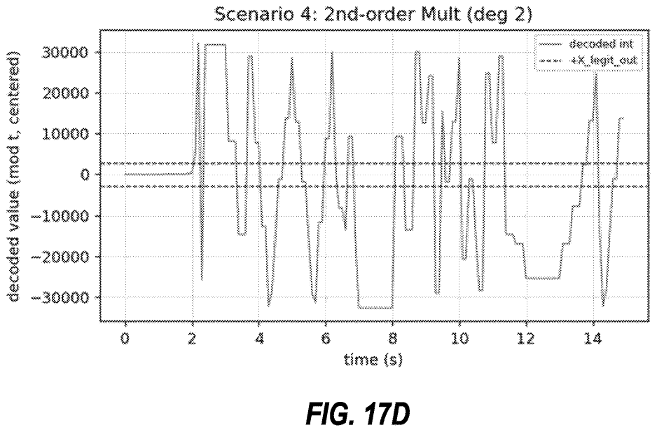

FIG. 17A through FIG. 17D illustrate decoded value behavior over time for various attack scenarios according to examples of the disclosed technology. The figures depict centered decoded integer values plotted against legitimate output boundaries, demonstrating how the encryption overflow trap can distinguish between low-order perturbations and higher-order attacks based on whether decoded values remain within predetermined thresholds.

In FIG. 17A through FIG. 17D, a vertical axis represents a decoded value with modulo t centering applied, and a horizontal axis represents time. Two horizontal dashed lines indicate legitimate output boundaries at positive and negative X_{legit_out} values. The legitimate output boundaries can be referred to herein as ±X_{legit_out} boundaries. The ±X_{legit_out} boundaries define a legitimate band within which decoded values remain during normal operation and under low-order attack conditions. The legitimate output bound X_{legit_out} can be calculated based on a maximum legitimate plaintext value, a legitimate multiplication depth, and a design margin parameter.

FIG. 17A illustrates decoded values over time for a scenario with no attack present in the system. In FIG. 17A, a solid line representing a decoded integer value remains substantially flat near zero throughout the duration of the graph. The decoded integer values remain within the ±X_{legit_out} boundaries throughout the measurement period. The stable behavior of the decoded values near zero indicates that the control system operates within expected parameters during normal operation without attack interference. FIG. 17A provides a baseline reference for comparison with attacked scenarios.

FIG. 17B illustrates decoded values under an additive attack scenario with degree zero. In FIG. 17B, a solid line representing the decoded integer value remains substantially flat near zero across the measurement range. The decoded integer values remain within the ±X_{legit_out} boundaries throughout the measurement period. Despite the additive attack, the decoded values do not exceed the legitimate output boundaries. The additive attack can be expressed as an attack function that adds a constant offset to the control signal. A model reference adaptive control algorithm can absorb the degree-zero additive perturbation, causing adaptive gains to drift to compensate for injected bias while the decoded values remain within the legitimate band. The encryption overflow trap does not fire during the additive attack scenario because the decoded values stay inside the ±X_{legit_out} boundaries.

FIG. 17C illustrates decoded value behavior over time for a first-order multiplicative attack scenario with degree one. In FIG. 17C, a solid line representing the decoded integer value remains substantially flat near zero throughout the time duration. The decoded integer values remain within the ±X_{legit_out} boundaries throughout the measurement period. Despite the first-order multiplicative attack, the decoded values do not exceed the legitimate output boundaries. The first-order multiplicative attack can be expressed as an attack function that multiplies the control signal by a time-varying coefficient. The adaptive control algorithm can absorb the gain error introduced by the first-order multiplicative attack, and the decoded values remain within the legitimate band. The encryption overflow trap does not fire during the first-order multiplicative attack scenario because the decoded values stay inside the ±X_{legit_out} boundaries.

FIG. 17D illustrates decoded values over time for a second-order multiplicative attack scenario with degree two. In FIG. 17D, a horizontal axis represents time measured in seconds, ranging from zero to approximately fourteen seconds. A vertical axis represents decoded values that are modulo t centered, ranging from approximately negative thirty thousand to positive thirty thousand. A solid line representing the decoded integer values exhibits significant oscillations between positive and negative values throughout the time period. The decoded values demonstrate sharp transitions between approximately positive thirty thousand and negative thirty thousand, with periods of relative stability interspersed with rapid changes. The ±X_{legit_out} boundaries are positioned near the zero line, indicating legitimate output thresholds. The decoded integer values frequently exceed the ±X_{legit_out} boundaries, with the oscillating pattern extending far beyond the legitimate band.

The distinction between the decoded value behavior in FIG. 17A through FIG. 17C compared to FIG. 17D relates to the degree of polynomial operations performed on the encrypted control commands. In FIG. 17A through FIG. 17C, the decoded values remain within the ±X_{legit_out} boundaries at every sample, resulting in zero trap triggers. The adaptive law absorbs degree-zero and degree-one perturbations, and the decrypted control signal stays inside the legitimate band. In FIG. 17D, the decoded values frequently leave the legitimate band, exceeding the ±X_{legit_out} boundaries by a factor of ten or more in some instances.

The second-order multiplicative attack applies a polynomial of degree two to the encrypted control commands. The degree-two polynomial operations inflate the plaintext value past a threshold t/2, causing the value to wrap during the modulo t operation. The wrapped value lands outside the legitimate band, enabling detection by the encryption overflow trap. The encryption overflow trap fires when the absolute value of the decoded integer exceeds X_{legit_out}, indicating a potential false data injection attack.

The encryption overflow trap can distinguish degree-two or greater attacks from degree-one or lesser attacks based on whether the decoded values exhibit excursions outside the ±X_{legit_out} boundaries. Attacks of degree zero or degree one do not accumulate encryption noise beyond detection thresholds and produce decoded values that remain within the legitimate band. Attacks of degree two or greater cause plaintext values to exceed the threshold t/2, resulting in wrapped values that fall outside the legitimate band. The encryption overflow trap provides a per-plaintext range check that detects attacks that inflate the encoded plaintext beyond legitimate computation ranges.

The decoded value overflow detection mechanism complements the ciphertext overflow detection mechanism and the plaintext overflow detection mechanism described above. The decoded value overflow detection operates by comparing the absolute value of the centered decoded integer against the X_{legit_out} threshold after decryption. When the absolute value exceeds X_{legit_out}, the trap fires with a plaintext overflow indication. The trap adds one decryption operation and one comparison operation per sampling step, providing detection capability with minimal computational overhead.

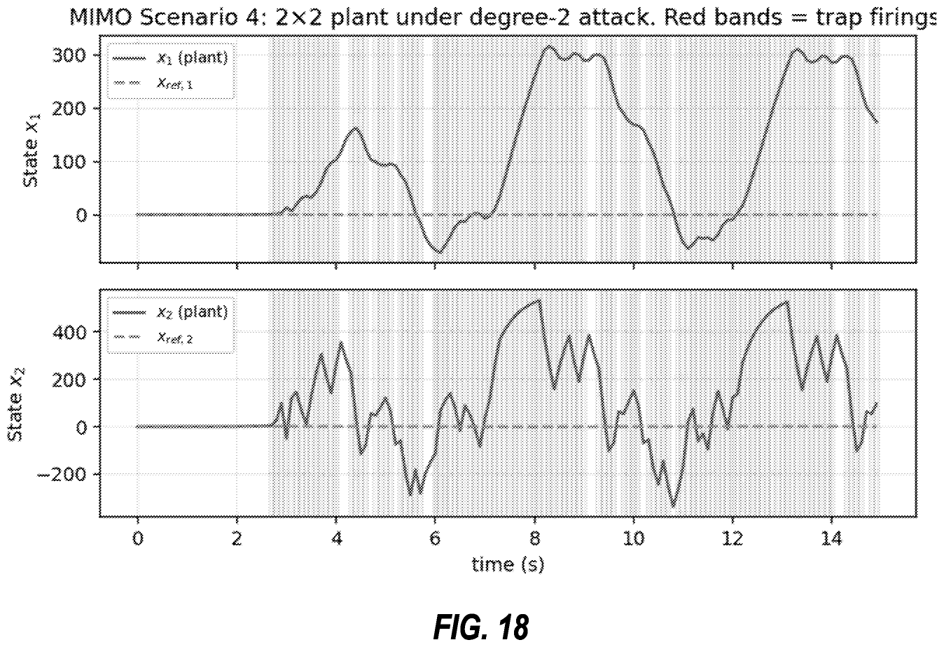

FIG. 18 illustrates a response of a 2×2 plant under a degree-2 attack scenario with trap firings indicated according to examples of the disclosed technology. FIG. 18 depicts two time-series graphs showing the behavior of a multi-input multi-output (MIMO) plant under a second-order multiplicative false data injection attack over a measurement period of approximately 14 to 15 seconds.

An upper graph in FIG. 18 displays a first state variable x₁ of the plant shown as a solid line, along with a corresponding first reference trajectory x_{ref,1} shown as a dashed line. A lower graph in FIG. 18 displays a second state variable x₂ of the plant shown as a solid line, along with a corresponding second reference trajectory x_{ref,2} shown as a dashed line. Both graphs include shaded bands distributed throughout the time axis, where the shaded bands indicate sampling instants at which the encryption overflow trap fired and detected the attack.

In the upper graph, the first plant state x₁ exhibits oscillatory deviations from the first reference trajectory, with values ranging from approximately negative one hundred to positive three hundred. The first plant state demonstrates divergence from the intended tracking behavior as the attack progresses. In the lower graph, the second plant state x₂ exhibits more pronounced deviations from the second reference trajectory, with values ranging from approximately negative three hundred to positive five hundred. The second plant state demonstrates substantial tracking error relative to the reference model.

The shaded bands representing trap firings appear throughout both graphs, with the trap firings beginning to appear after approximately 2.5 to 3 seconds into the measurement period. The delay in initial trap firing corresponds to the time for the plant states to grow sufficiently large such that the squared control signal exceeds a plaintext modulus threshold and triggers the modular overflow detection mechanism. Once the plant states have been excited to sufficient magnitude, the control signal u grows large enough for u² to exceed a threshold value t/2 with high probability.

The encryption overflow trap can detect the second-order multiplicative attack through noise accumulation caused by polynomial operations on encrypted values. The second-order multiplicative attack applies a polynomial of degree two to the encrypted control commands. The degree-two polynomial operations inflate the plaintext value past the threshold t/2, causing the value to wrap during a modulo t operation. The wrapped value lands outside a legitimate band defined by ±X_{legit\_out} boundaries, enabling detection by the encryption overflow trap.

The trap fires when an absolute value of a decoded integer exceeds X_{legit\_out}, indicating a potential false data injection attack. In the MIMO configuration depicted in FIG. 18, the trap can trigger on a substantial fraction of samples during the attack period. The empirical detection probability Pₑₘₚ can reach approximately 0.727, with the trap triggering on 109 of 150 samples in some implementations. The first detection can occur at approximately t=2.7 seconds, confirming that the overflow trap mechanism extends from single-input single-output (SISO) systems to MIMO configurations.

The cumulative detection probability over multiple iterations can be calculated according to:

P_{ξ}=1−(1−P_{detect})^{ξ}
where P_{detect} represents the per-sample detection probability and ξ represents the number of iterations or samples examined. With a per-sample detection probability of approximately 0.77, the cumulative detection probability approaches unity within a small number of iterations, providing near-certainty of attack detection.

The visualization in FIG. 18 demonstrates that the encryption overflow trap can distinguish degree-two or greater attacks from degree-one or lesser attacks based on whether the encrypted control commands exhibit anomalous noise levels. Attacks of degree zero or degree one do not accumulate encryption noise beyond detection thresholds and can be compensated by an adaptive control algorithm without triggering the trap. Attacks of degree two or greater cause encryption noise to increase in a multiplicative fashion, resulting in noise accumulation that exceeds ciphertext and plaintext thresholds.

The plant state divergence visible in FIG. 18 illustrates that the second-order multiplicative attack is destabilizing to the control system. The trap detects the attack in time to enable protective action, such as stopping an actuator or switching to a fail-safe mode. The shaded bands coincide with large excursions in the decoded control signal, confirming that the trap mechanism fires at sampling instants when the degree-2 polynomial inflates the plaintext past the modular boundary and wraps to a centered value that is distinguishable from legitimate computations.

The homomorphic encryption described herein can be implemented using various encryption schemes, each with distinct characteristics suited for different applications. As described above, the remote controller can encrypt control commands using homomorphic encryption. The homomorphic encryption can comprise at least one of a BFV encryption scheme, a BGV encryption scheme, or a CKKS encryption scheme.

The homomorphic encryption can comprise at least one of a BFV encryption scheme, a BGV encryption scheme, a CKKS encryption scheme, or Dyer's Somewhat Homomorphic Encryption (SHE) scheme as described in paragraph [0268].

In homomorphic encryption, every ciphertext includes a noise component that grows with each operation. Once the noise reaches a threshold, decryption fails. The noise budget can be quantified in bits, where fresh ciphertexts start with a certain noise budget that decreases as operations are performed. For BFV and BGV schemes, the noise budget is well-defined, while for CKKS the concept is replaced by precision and scale.

The BFV encryption scheme is a lattice-based encryption scheme operating over a quotient ring. Plaintexts reside in a smaller ring with a plaintext modulus. A BFV ciphertext is a pair of elements such that decryption divides by a ratio of moduli and rounds, producing the plaintext centered in a range. Homomorphic addition is componentwise addition of the ciphertext pair, and homomorphic multiplication produces a degree-two ciphertext that is relinearized back to a pair using evaluation keys. Each ciphertext-by-ciphertext multiplication grows the noise term roughly multiplicatively. The BFV scheme provides balanced detection performance with clear discrimination between normal operations and attacks, making the BFV scheme suitable for applications requiring precise attack detection.

For the BFV encryption scheme, the detection probability can be defined as a function of the remaining noise budget according to:

Pₚₚ=min(1.0,γ·(Bₘₐₓ−B_{remaining}/Bₘₐₓ)²)
where Bₘₐₓ is a maximum noise budget for a fresh ciphertext, B_{remaining} is a current noise budget, and γ is a tunable detection sensitivity parameter.

The BGV encryption scheme also uses noise budget but with a level-based calculation that accounts for specific noise characteristics of the BGV scheme. The BGV scheme can offer high detection rates and can provide zero false positives during normal operations while maintaining attack detection capability. For the BGV encryption scheme, a modified exponent can be used according to:

Pₚₚ=min(1.0,γ·(1.0−B_{remaining}/Bₘₐₓ)^{1.5})

The modified exponent of 1.5 reflects different noise growth patterns during operations in the BGV scheme compared to the BFV scheme.

The CKKS encryption scheme does not provide a direct noise budget measure, so a scale-based detection approach can be used. For the CKKS encryption scheme, the detection probability can be calculated according to:

Pₚₚ=min(1.0,γ·|s−s_{expected}|/s_{expected}·α)
where s is a current scale of the ciphertext, s_{expected} is an expected scale based on the operations performed, γ is a sensitivity parameter, and α is a scale factor that adjusts the detection probability based on the encryption level. The CKKS scheme demonstrates attack detection capability but can show higher sensitivity to scale changes, and parameter selection can be adjusted to reduce false positive rates.

The homomorphic encryption can be implemented using Dyer's Somewhat Homomorphic Encryption (SHE) scheme operating over integers. Dyer's SHE scheme is an asymmetric encryption scheme that can handle polynomials of higher degree. The scheme can be summarized as follows. Key generation involves setting security parameters λ, ρ, and ρ′. A λ-bit prime p, a v-bit prime κ, and an η-bit prime q are randomly chosen, where v=ρ′−ρ and η=λ²ρ′−λ. A key k=(κ, p) is generated and N=pq is published. Encryption of a plaintext m is performed by computing c=m+sκ+wp mod N, where s and w are random noise values. Decryption of a ciphertext c is performed by computing m=(c mod p) mod κ.

For Dyer's SHE scheme, the maximum allowable plaintext and ciphertext values are bounded by κ>(ζ+1)^{d}_{SHE}M^{d}_{SHE} and p>(ζ+1)^{d}_{SHE}(M+κ/2)^{d}_{SHE}, where ζ is the number of variables, d_{SHE} is the maximum degree of operations in the SHE scheme, and M is the largest expected value in the algorithm's operation. Dyer's SHE scheme can provide faster computation times compared to other SHE schemes, with execution frequencies suitable for real-time operations.

The homomorphic encryption can be implemented using fully homomorphic encryption (FHE) for unlimited operations. FHE allows unlimited ciphertext operations of any type, including both addition and multiplication without restriction on the number of operations. FHE implementations can involve bootstrapping operations that refresh ciphertext noise, enabling continued computation beyond the noise limits of somewhat homomorphic encryption schemes. FHE can result in larger execution delays due to bootstrapping steps, and thus FHE implementations can be selected based on application requirements where unlimited operations are prioritized over execution speed.

The encryption can be implemented using hybrid encryption approaches that combine multiple encryption schemes. Hybrid approaches can utilize multiplicative and additive partially homomorphic encryption (PHE) schemes in unison. PHE schemes allow either addition or multiplication in the cipherspace but not both. By combining multiple PHE schemes, hybrid approaches can achieve both addition and multiplication capabilities while potentially reducing computational overhead compared to FHE. Hybrid encryption approaches can be selected based on the specific computational requirements of the control algorithm and the balance between security and performance.

Custom encryption schemes can be optimized for specific robot control applications, including depth-compressed implementations such as the Modified Model Reference Adaptive Controller (MMRAC) with Modified State Space (MSS) formulation. Custom schemes can be designed to match the computational depth and operation types of particular control algorithms. For example, a depth-compressed model reference adaptive control implementation can reduce encryption depth from d=8 to d=4, enabling a reduction in encryption key length from approximately 7415 bits to approximately 1027 bits. Custom encryption schemes can be optimized by reformulating control algorithms such that constants are grouped via matrix manipulation and algorithm constraints before encryption. The grouped constants form a modified state space that remains encrypted during algorithm execution. Custom encryption schemes can maintain real-time integrity without unreasonably large ciphertext values while preserving the security benefits of the overflow detection mechanism.

Somewhat homomorphic encryption (SHE), also referred to as leveled FHE, allows both addition and multiplication to be implemented in ciphertext in a limited amount. SHE can handle both mathematical operations without large bootstrapping execution times, making SHE suitable for encrypted cyber-physical systems where real-time performance is a consideration. The encryption overflow trap can be implemented with any of the described encryption schemes, with the detection probability formulas adjusted according to the noise characteristics of the selected scheme.

The non-equivariant state monitoring signature function can be implemented using various mathematical constructs beyond polynomial functions. Alternative implementations can enhance resilience against estimation attacks and can address different symmetry properties in robot dynamics.

The non-equivariant state monitoring signature function can be implemented using transcendental functions such as exponential functions or trigonometric functions. Exponential functions can provide rapid nonlinear growth characteristics that resist estimation by linear methods. An exponential-based signature function can be expressed as:

$$ϕ ( {x}_{1} , {x}_{2} ) = {e}^{{a}_{1} {x}_{1} + {b}_{1} {x}_{2}} + {e}^{{a}_{2} {x}_{1}^{2} + {b}_{2} {x}_{2}^{2}}$$

where x₁ and x₂ represent state variables, and a₁, a₂, b₁, and b₂ represent coefficients. The exponential terms introduce nonlinearity that can make the signature function difficult for an attacker to estimate through standard least squares estimation techniques.

Trigonometric functions can be incorporated into the signature function to introduce periodic nonlinearity. A trigonometric-based signature function can be expressed as:

φ(x₁,x₂)=c₁ sin(x₁)cos(x₂)+c₂ sin(x₁+x₂)+c₃ cos(x₁−x₂)
where c₁, c₂, and c₃ represent coefficients. The trigonometric terms can provide sensitivity to both magnitude and sign changes in state variables. Combinations of exponential and trigonometric functions can be used to construct signature functions with multiple layers of nonlinearity.

The non-equivariant state monitoring signature function can be implemented using piecewise-defined functions with discontinuities. Discontinuous functions can provide abrupt changes in signature values at specific state boundaries, making the signature function difficult to estimate or invert. A piecewise-defined signature function can be expressed as:

$$ϕ ( x ) = \{ \begin{matrix}{f}_{1} ( x ) & if g ( x ) > 0 \\ {f}_{2} ( x ) & if g ( x ) \leq 0\end{matrix}$$

where f₁(x) and f₂(x) represent different function expressions, and g(x) represents a boundary condition function. The discontinuity at the boundary defined by g(x)=0 can create detectable inconsistencies when an attacker attempts to apply a transformation that crosses the boundary. Piecewise continuous functions can address multiple symmetries within heterogeneous robot teams where different robots can have different dynamic characteristics.

The non-equivariant state monitoring signature function can operate on transformed state spaces rather than directly on state measurements. A state space transformation can be applied to the state measurements before computing the signature value. The transformed state space approach can be expressed as:

φ(x)=h(T(x))
where T(x) represents a state space transformation function and h represents a signature computation function applied to the transformed state. The state space transformation T can include coordinate transformations, normalization operations, or projections onto different manifolds. By operating on a transformed state space, the signature function can exploit geometric properties of the transformed space that differ from the original state space. The transformation T can be selected to break symmetries present in the original state space that an attacker can exploit.

The non-equivariant state monitoring signature function can be implemented using neural network architectures with non-equivariant properties. A neural network-based signature function can learn complex nonlinear mappings from state measurements to signature values. The neural network architecture can be designed to lack equivariance with respect to transformations that can be used in attacks.

A feedforward neural network with multiple hidden layers can be used to implement the signature function. The neural network can be expressed as:

φ(x)=Wₙσ(Wₙ₋₁σ( . . . σ(W₁x+b₁) . . . )+bₙ₋₁)+bₙ
where W₁ through Wₙ represent weight matrices, b₁ through bₙ represent bias vectors, and σ represents a nonlinear activation function. The activation function σ can be a rectified linear unit (ReLU), hyperbolic tangent (tanh), or another nonlinear function. The weight matrices and bias vectors can be trained or selected to ensure non-equivariance with respect to scaling, reflection, and permutation transformations.

The neural network architecture can incorporate asymmetric weight structures to ensure non-equivariance with respect to permutation transformations. The neural network can be trained using state measurement data and corresponding signature values, with a loss function that penalizes equivariance with respect to target transformations. The neural network-based signature function can provide flexibility in adapting to different robot dynamics and attack scenarios.

When constructing alternative signature functions, the design can balance complexity with computational efficiency. The signature function can be selected based on the specific symmetry properties of the target plant dynamics. A well-informed choice for the design of the non-equivariant state monitoring signature function can avoid possessing the same symmetry as the target plant dynamics. The alternative implementations can maintain the properties of being injective, nonlinear, and noninvertible to resist estimation and inversion attacks.

The parameters of the non-equivariant state monitoring signature function and the encryption parameters can be periodically updated to prevent adversarial estimation of the signature function and the defense mechanisms. Periodic parameter updates create a moving target that increases the difficulty for an attacker to learn and replicate the defenses through observation.

For the non-equivariant state monitoring signature function, the update process can involve securely generating new signature function parameters at the remote controller. The signature function parameters can be securely generated at the controller and transmitted to the motion control unit through a secure channel. The secure channel can utilize authenticated encryption to prevent interception or modification of the parameters during transmission. The secure channel can be separate from the communication network used for transmitting state measurements and control commands, or the secure channel can utilize additional cryptographic protections layered on top of the communication network.

The transition to new signature function parameters can be coordinated to maintain continuous monitoring during updates. The coordination can involve synchronizing the parameter update at both the motion control unit and the remote controller such that both entities begin using the new signature function parameters at the same time instant. In some cases, the coordination can involve a handshake protocol where the motion control unit acknowledges receipt of the new parameters before both entities transition to using the new parameters. The coordinated transition can prevent gaps in monitoring coverage that an attacker could exploit during the parameter update process.

For the encryption overflow trap, the adaptation can involve dynamically adjusting the encryption parameters based on observed noise patterns. The encryption parameters can be dynamically adjusted based on observed noise patterns in the encrypted control commands during normal operation. The dynamic adjustment can involve monitoring the noise budget consumption during legitimate operations and adjusting the detection thresholds to account for variations in noise accumulation. In some cases, the encryption parameters can be adjusted to increase detection sensitivity when the observed noise patterns indicate potential attack activity.

The encryption keys can be periodically refreshed to enhance security. Periodic key refresh can involve generating new encryption keys and distributing the new keys to both the remote controller and the motion control unit through a secure key distribution protocol. The key refresh interval can be selected based on the security requirements of the application and the computational overhead associated with key generation and distribution. In some cases, the key refresh can be triggered by detection of anomalous activity or by expiration of a predetermined time interval.

The detection thresholds can be updated based on observed system behavior. The detection thresholds for both the non-equivariant state monitoring signature function and the encryption overflow trap can be adjusted based on statistical analysis of system behavior during normal operation. For the signature function, the detection threshold can be adjusted based on the observed variance in signature value differences between the motion control unit and the remote controller during unattacked operation. For the encryption overflow trap, the detection threshold can be adjusted based on the observed noise budget consumption during legitimate control operations.

The frequency of parameter updates can be selected to balance security against computational and communication overhead. More frequent parameter updates can reduce the time window during which an attacker can successfully estimate the defense parameters, but more frequent updates can also increase the computational burden on the system. The update frequency can be selected based on the complexity of the signature function, the sampling rate of the control system, and the estimated time for an attacker to successfully estimate the signature function parameters through observation.

The adaptive approach can increase the difficulty of mounting successful attacks because an attacker attempting to estimate the signature function or the encryption parameters faces a continuously evolving target. The security of the non-equivariant state monitoring signature function can depend on the complexity of the signature function, which determines the sampling complexity for estimation, and the frequency of function parameter updates, which limits the window for successful estimation. The security of the encryption overflow trap can depend on the unpredictability of the random noise components in the encryption, the cryptographic strength of the chosen encryption scheme, and the tuning of encryption parameters to maximize detection probability while minimizing false positives.

The defense system can be integrated with additional security mechanisms to provide layered protection against false data injection attacks. The integration of multiple security mechanisms can create defense-in-depth architectures where different mechanisms address different attack vectors and provide redundant protection.

The defense system can be integrated with watermarking techniques for data authentication. Watermarking involves embedding authentication information within control signals or state measurements. A watermark signal can be superimposed on control commands transmitted from the remote controller to the motion control unit. The watermark signal can comprise a pseudo-random sequence generated using a shared secret between the remote controller and the motion control unit. The motion control unit can extract the watermark from received control commands and verify the authenticity of the commands by comparing the extracted watermark with a locally generated expected watermark.

In some cases, the watermarking can be applied to state measurements transmitted from the motion control unit to the remote controller. The motion control unit can embed a watermark signal within the state measurements before transmission. The remote controller can extract and verify the watermark to authenticate the received state measurements. The watermark verification can operate in parallel with the non-equivariant state monitoring signature function and the encryption overflow trap, providing an additional layer of authentication.

The watermark signal can be designed to be statistically independent of the control signals and state measurements. The watermark amplitude can be selected to be small relative to the control signal amplitude such that the watermark does not interfere with control performance. In some cases, the watermark can be designed to be orthogonal to the control signal in a frequency domain or a time domain. The watermark parameters can be periodically updated using a secure key exchange protocol to prevent an attacker from learning and replicating the watermark sequence.

The defense system can be integrated with zero-knowledge proofs for secure verification. Zero-knowledge proofs allow one party to prove knowledge of a value or the correctness of a computation to another party without revealing the underlying information. In the context of the defense system, zero-knowledge proofs can be used to verify that control commands or state measurements satisfy certain properties without revealing the actual values.

The remote controller can generate a zero-knowledge proof that demonstrates the control commands were computed correctly according to a specified control algorithm. The motion control unit can verify the zero-knowledge proof before applying the control commands to the actuators. The verification confirms that the control commands are consistent with the expected control algorithm without requiring the motion control unit to have access to the controller's internal state or parameters.

In some cases, zero-knowledge proofs can be used to verify properties of the encrypted control commands without decryption. The remote controller can generate a zero-knowledge proof that the encrypted control commands fall within a specified range or satisfy specified constraints. The motion control unit can verify the zero-knowledge proof on the encrypted commands before decryption, providing an additional check against manipulated commands.

Zero-knowledge proofs can also be used to verify the correctness of signature function computations. The motion control unit can generate a zero-knowledge proof that the first signature value was computed correctly from the state measurements using the non-equivariant state monitoring signature function. The remote controller can verify the zero-knowledge proof to confirm that the signature computation was performed correctly, providing assurance against attacks that attempt to manipulate the signature value independently of the state measurements.

The defense system can be integrated with blockchain-based audit trails for attack forensics. A blockchain can provide a tamper-resistant distributed ledger for recording security-related events in the networked robot control system. The blockchain-based audit trail can record detection events, parameter updates, and system state information in a manner that cannot be altered retroactively.

When the non-equivariant state monitoring signature function detects a potential attack based on a difference between the first signature value and the second signature value exceeding a predefined threshold, the detection event can be recorded on the blockchain. The recorded event can include a timestamp, the signature values, the state measurements, and other contextual information. The blockchain record provides a forensic trail that can be used to analyze attack patterns and identify attack sources.

When the encryption overflow trap detects anomalous noise levels in the encrypted control commands, the detection event can be recorded on the blockchain. The recorded event can include the noise budget values, the detection probability, and the encrypted command values. The blockchain record can be used to correlate overflow trap detections with other security events and to identify patterns in attack behavior.

The blockchain-based audit trail can record parameter updates for the non-equivariant state monitoring signature function and the encryption overflow trap. When signature function parameters are updated, the update event can be recorded on the blockchain along with a hash of the new parameters. The blockchain record provides a verifiable history of parameter changes that can be used to audit the security configuration of the system.

In some cases, the blockchain can be implemented as a private or permissioned blockchain where participation is restricted to authorized entities within the networked robot control system. The private blockchain can provide faster transaction processing compared to public blockchains while maintaining the tamper-resistance properties. In other cases, the blockchain can be implemented as a consortium blockchain where multiple organizations operating networked robot control systems share a common audit trail.

The blockchain-based audit trail can support post-incident analysis and forensic investigation. When an attack is detected or suspected, investigators can query the blockchain to retrieve a complete history of security events, parameter changes, and system state information. The tamper-resistant nature of the blockchain ensures that the forensic evidence has not been altered by an attacker attempting to cover traces of the attack.

The integration of watermarking, zero-knowledge proofs, and blockchain-based audit trails with the non-equivariant state monitoring signature function and the encryption overflow trap can provide a comprehensive security architecture. The watermarking provides data authentication that can detect message substitution attacks. The zero-knowledge proofs provide verification of computational correctness without revealing sensitive information. The blockchain-based audit trail provides forensic capability for post-incident analysis. The combined integration can address different aspects of security including authentication, verification, and accountability.

The disclosed defense mechanisms can be applied to various application domains where networked robot control systems operate and face cybersecurity threats from false data injection attacks.

The robot system can comprise an autonomous vehicle. Autonomous vehicles rely on networked communication systems to receive navigation commands and transmit sensor data to remote controllers or cloud-based processing systems. The non-equivariant state monitoring signature function and the encryption overflow trap can be implemented in autonomous vehicle control architectures to detect false data injection attacks that attempt to manipulate vehicle trajectory or behavior. The state measurements in autonomous vehicle applications can include position coordinates, velocity vectors, orientation angles, and sensor readings from lidar, radar, or camera systems. The remote controller can compute trajectory planning commands and transmit encrypted control commands to the autonomous vehicle via wireless communication networks.

The robot system can comprise a medical robot. Medical robots operate in environments where safety and precision are considerations, and false data injection attacks can pose risks to patient safety. The defense mechanisms can be applied to surgical robots, rehabilitation robots, diagnostic robots, and patient care robots that communicate with remote controllers via hospital networks or cloud-based systems. The state measurements in medical robot applications can include end-effector positions, joint angles, force measurements, and patient physiological data. The non-equivariant state monitoring signature function can detect transformation-based attacks that attempt to manipulate surgical instrument positions or force feedback signals. The encryption overflow trap can detect covert attacks that attempt to substitute malicious control commands for legitimate surgical commands.

The defense mechanisms can be applied to multi-robot teams operating under centralized or decentralized communication frameworks. In centralized communication frameworks, a central controller computes control commands for multiple robots and transmits the commands via a shared communication network. The non-equivariant state monitoring signature function can be implemented at each robot in the multi-robot team, with signature values transmitted to the central controller for verification. The encryption overflow trap can monitor encrypted control commands transmitted from the central controller to each robot. In decentralized communication frameworks, robots communicate directly with neighboring robots to coordinate behavior. The defense mechanisms can be implemented in peer-to-peer communication channels between robots, with each robot computing signature values for state measurements transmitted to neighboring robots and monitoring encrypted commands received from neighboring robots. The multi-robot team applications can include warehouse logistics systems, search and rescue operations, agricultural robotics, and swarm robotics.

The robot system can comprise an industrial automation system. Industrial automation systems include manufacturing robots, material handling systems, assembly line robots, and process control systems that operate within factory networks. The defense mechanisms can protect industrial automation systems from false data injection attacks that attempt to disrupt manufacturing processes, damage equipment, or compromise product quality. The state measurements in industrial automation applications can include robot arm positions, conveyor belt speeds, process temperatures, pressure readings, and quality inspection data. The remote controller can be implemented as a programmable logic controller (PLC), a distributed control system (DCS), or a cloud-based manufacturing execution system (MES) that communicates with industrial robots via industrial communication protocols. The non-equivariant state monitoring signature function and the encryption overflow trap can be integrated into industrial communication architectures to detect attacks targeting industrial control systems.

The disclosed technology can be further understood according to the following clauses:
Clause 1: A computer-implemented method for detecting false data injection attacks in a networked robot control system, comprising:
receiving, at a motion control unit, state measurements from a robot system;
processing the state measurements through a non-equivariant state monitoring signature function to compute a first signature value, wherein the non-equivariant state monitoring signature function is configured such that no transformation exists that can simultaneously transform both the state measurements and the first signature value while maintaining mathematical consistency;
transmitting the first signature value and the state measurements to a remote controller via a communication network;
at the remote controller, processing the received state measurements through the non-equivariant state monitoring signature function to compute a second signature value;
comparing the first signature value with the second signature value;
encrypting control commands at the remote controller using homomorphic encryption;
transmitting the encrypted control commands to the motion control unit via the communication network;
monitoring the encrypted control commands for anomalous noise levels indicative of unauthorized manipulation; and
generating an alert responsive to at least one of:
a difference between the first signature value and the second signature value exceeding a predefined threshold; or
the encrypted control commands exhibiting anomalous noise levels.
Clause 2: The method of clause 1, wherein the non-equivariant state monitoring signature function is a polynomial function of state variables of the robot system.
Clause 3: The method of clause 2, wherein the polynomial function includes terms of different degrees to ensure non-equivariance with respect to scaling transformations.
Clause 4: The method of clause 2, wherein the polynomial function includes coupled terms between different state variables to ensure non-equivariance with respect to permutation transformations.
Clause 5: The method of clause 2, wherein the polynomial function includes odd-powered terms to ensure sensitivity to sign changes from reflection transformations.
Clause 6: The method of clause 1, wherein monitoring the encrypted control commands for anomalous noise levels comprises:
calculating a detection probability based on a remaining noise budget of the encrypted control commands;
comparing the detection probability to a detection threshold; and
determining that anomalous noise levels are present responsive to the detection probability exceeding the detection threshold.
Clause 7: The method of clause 6, wherein the detection probability is calculated according to:

Pₚₚ=min(1.0,γ·(Bₘₐₓ−B_{remaining}/Bₘₐₓ)²)
where Bₘₐₓ is a maximum noise budget for a fresh ciphertext, B_{remaining} is a current noise budget, and y is a sensitivity parameter.
Clause 8: The method of clause 1, wherein the homomorphic encryption comprises at least one of:
a BFV encryption scheme;
a BGV encryption scheme; or
a CKKS encryption scheme.
Clause 9: The method of clause 1, wherein the non-equivariant state monitoring signature function is configured to detect affine transformation-based attacks that apply coordinated transformations to both control commands and state measurements.
Clause 10: The method of clause 1, wherein monitoring the encrypted control commands for anomalous noise levels is configured to detect covert attacks that implement a malicious controller between the robot system and the remote controller.
Clause 11: The method of clause 1, further comprising periodically updating parameters of the non-equivariant state monitoring signature function to prevent adversarial estimation of the signature function.
Clause 12: The method of clause 1, wherein the robot system comprises a mobile robot with non-holonomic constraints.
Clause 13: A system for detecting false data injection attacks in a networked robot control system, comprising:
a robot plant comprising actuators and sensors;
a motion control unit coupled to the robot plant, the motion control unit comprising:
a first processor;
a first memory coupled to the first processor; and
first instructions stored in the first memory that, when executed by the first processor, cause the motion control unit to:
receive state measurements from the sensors;
process the state measurements through a non-equivariant state monitoring signature function to compute a first signature value; and
transmit the first signature value and the state measurements via a communication network;
a remote controller coupled to the motion control unit via the communication network, the remote controller comprising:
a second processor;
a second memory coupled to the second processor; and
second instructions stored in the second memory that, when executed by the second processor, cause the remote controller to:
receive the first signature value and the state measurements from the motion control unit;
process the received state measurements through the non-equivariant state monitoring signature function to compute a second signature value;
compare the first signature value with the second signature value to detect affine transformation-based attacks;
encrypt control commands using homomorphic encryption; and
transmit the encrypted control commands to the motion control unit; and
an encryption overflow detection module configured to monitor the encrypted control commands for anomalous noise levels and generate an alert responsive to detecting noise levels exceeding a predetermined threshold.
Clause 14: The system of clause 13, wherein the non-equivariant state monitoring signature function comprises a polynomial function including terms of at least two different degrees.
Clause 15: The system of clause 13, wherein the encryption overflow detection module is configured to calculate a detection probability based on a remaining noise budget of the encrypted control commands.
Clause 16: The system of clause 13, wherein the robot plant comprises at least one of an industrial manipulator or a mobile robot.
Clause 17: A computer-implemented method for detecting false data injection attacks in an encrypted networked robot control system, comprising:
determining encryption parameters for homomorphic encryption based on a maximum expected plaintext value and a maximum degree of operations to be performed in the control system;
encrypting control commands using the homomorphic encryption with the determined encryption parameters;
transmitting the encrypted control commands via a communication network to a robot system comprising actuators configured to execute physical movements;
receiving the encrypted control commands at the robot system;
monitoring a noise characteristic of the encrypted control commands;
calculating a detection probability based on the noise characteristic; and
generating an alert responsive to the detection probability exceeding a predefined threshold, wherein the alert indicates a potential false data injection attack.
Clause 18: The method of clause 17, wherein determining encryption parameters comprises:
determining a value κ that satisfies κ>(ζ+1)^{d}M^{d}, where ζ is a number of variables, d is the maximum degree of operations, and M is the maximum expected plaintext value; and
determining a value p that satisfies p>(ζ+1)_{d}(M+κ/2)^{d}.
Clause 19: The method of clause 17, wherein the noise characteristic comprises a remaining noise budget of the encrypted control commands, and wherein the detection probability increases as the remaining noise budget decreases.
Clause 20: The method of clause 17, wherein the method is configured to detect attacks that perform polynomial operations of degree two or greater on the encrypted control commands.

A number of implementations have been described. Nevertheless, it will be understood that various modifications may be made without departing from the spirit and scope of the disclosure. Accordingly, other implementations are within the scope of the following claims.

1. A computer-implemented method for detecting false data injection attacks in a networked robot control system, comprising:
receiving, at a motion control unit, state measurements from a robot system;
processing the state measurements through a non-equivariant state monitoring signature function to compute a first signature value, wherein the non-equivariant state monitoring signature function is configured such that no transformation exists that can simultaneously transform both the state measurements and the first signature value while maintaining mathematical consistency;
transmitting the first signature value and the state measurements to a remote controller via a communication network;
at the remote controller, processing the received state measurements through the non-equivariant state monitoring signature function to compute a second signature value;
comparing the first signature value with the second signature value;
encrypting control commands at the remote controller using homomorphic encryption;
transmitting the encrypted control commands to the motion control unit via the communication network;
detecting an overflow condition associated with the encrypted control commands, the overflow condition comprising at least one of a plaintext overflow condition, a ciphertext overflow condition, a centered-decoded-value range violation, or a remaining-noise-budget violation; and
generating an alert responsive to at least one of:
a difference between the first signature value and the second signature value exceeding a predefined threshold; or
detection of the overflow condition.

2. The method of claim 1, wherein the non-equivariant state monitoring signature function is a polynomial function of state variables of the robot system.

3. The method of claim 2, wherein the polynomial function includes terms of different degrees to break homogeneity and ensure non-equivariance with respect to scaling transformations.

4. The method of claim 2, wherein the polynomial function includes coupled terms between different state variables to ensure non-equivariance with respect to permutation transformations.

5. The method of claim 2, wherein the polynomial function includes odd-powered terms to ensure sensitivity to sign changes from reflection transformations.

6. The method of claim 1, wherein detecting the overflow condition comprises at least one of:
determining that a decoded plaintext value of a decrypted control command falls within a plaintext overflow detection zone;
determining that a ciphertext value of the encrypted control commands falls within a ciphertext overflow detection zone;
determining that an absolute value of a centered decoded integer of a decrypted control command exceeds a legitimate output bound; or
calculating a detection probability based on a remaining noise budget of the encrypted control commands, comparing the detection probability to a detection threshold, and determining that a remaining-noise-budget violation is present responsive to the detection probability exceeding the detection threshold.

7. The method of claim 6, wherein the detection probability is calculated according to:
Pₚₚ=min(1.0,γ·(Bₘₐₓ−B_{remaining}/Bₘₐₓ)²)
where Bₘₐₓ is a maximum noise budget for a fresh ciphertext, B_{remaining} is a current noise budget, and γ is a sensitivity parameter.

8. The method of claim 1, wherein the homomorphic encryption comprises at least one of:
a BFV encryption scheme;
a BGV encryption scheme; or
a CKKS encryption scheme.

9. The method of claim 1, wherein the non-equivariant state monitoring signature function is configured to detect affine transformation-based attacks that apply coordinated transformations to both control commands and state measurements.

10. The method of claim 1, wherein monitoring the encrypted control commands for anomalous noise levels is configured to detect covert attacks that implement a malicious controller between the robot system and the remote controller.

11. The method of claim 1, further comprising periodically updating parameters of the non-equivariant state monitoring signature function to prevent adversarial estimation of the signature function.

12. The method of claim 1, wherein the robot system comprises a mobile robot with non-holonomic constraints.

13. A system for detecting false data injection attacks in a networked robot control system, comprising:
a robot plant comprising actuators and sensors;
a motion control unit coupled to the robot plant, the motion control unit comprising:
a first processor;
a first memory coupled to the first processor; and
first instructions stored in the first memory that, when executed by the first processor, cause the motion control unit to:
receive state measurements from the sensors;
process the state measurements through a non-equivariant state monitoring signature function to compute a first signature value; and
transmit the first signature value and the state measurements via a communication network;
a remote controller coupled to the motion control unit via the communication network, the remote controller comprising:
a second processor;
a second memory coupled to the second processor; and
second instructions stored in the second memory that, when executed by the second processor, cause the remote controller to:
receive the first signature value and the state measurements from the motion control unit;
process the received state measurements through the non-equivariant state monitoring signature function to compute a second signature value;
compare the first signature value with the second signature value to detect affine transformation-based attacks;
encrypt control commands using homomorphic encryption; and
transmit the encrypted control commands to the motion control unit; and
an encryption overflow detection module configured to decrypt the encrypted control commands to obtain a centered decoded plaintext value, compare an absolute value of the centered decoded plaintext value against a legitimate output bound, and generate an alert responsive to the absolute value of the centered decoded plaintext value exceeding the legitimate output bound.

14. The system of claim 13, wherein the non-equivariant state monitoring signature function comprises a polynomial function including terms of at least two different degrees.

15. The system of claim 13, wherein the encryption overflow detection module is configured to calculate a detection probability based on a remaining noise budget of the encrypted control commands.

16. The system of claim 13, wherein the robot plant comprises at least one of an industrial manipulator or a mobile robot.

17. A computer-implemented method for detecting false data injection attacks in an encrypted networked robot control system, comprising:
determining encryption parameters for homomorphic encryption based on a maximum expected plaintext value and a maximum degree of operations to be performed in the control system;
encrypting control commands using the homomorphic encryption with the determined encryption parameters;
transmitting the encrypted control commands via a communication network to a robot system comprising actuators configured to execute physical movements;
receiving the encrypted control commands at the robot system;
monitoring the encrypted control commands for an overflow condition associated with the homomorphic encryption; and
generating an alert responsive to detection of the overflow condition, wherein the alert indicates a potential false data injection attack.

18. The method of claim 17, wherein determining encryption parameters comprises:
determining a value κ that satisfies κ>(ζ+1)^{d}_{SHE}M^{d}_{SHE}, where ζ is a number of variables, d_{SHE} is the maximum degree of operations in the Dyer somewhat homomorphic encryption scheme, and M is the maximum expected plaintext value; and
determining a value p that satisfies p>(ζ+1)^{d}_{SHE}(M+κ/2)^{d}_{SHE}.

19. The method of claim 17, wherein monitoring the encrypted control commands for the overflow condition comprises calculating a detection probability based on a remaining noise budget of the encrypted control commands, and wherein the detection probability increases as the remaining noise budget decreases.

20. The method of claim 17, wherein the method is configured to detect attacks that perform polynomial operations of degree two or greater on the encrypted control commands.
